(19) United States
(12) Patent Application Publication
(10) Pub. No.: US 2025/0124854 A1
(43) Pub. Date: Apr. 17, 2025

(54) PIXEL AND DISPLAY DEVICE INCLUDING THE SAME

(71) Applicant: Samsung Display Co., LTD., Yongin-si (KR)

(72) Inventors: DONGWOO KIM, Yongin-si (KR); KWIHYUN KIM, Yongin-si (KR); YEONKYUNG KIM, Yongin-si (KR)

(21) Appl. No.: 18/903,137

(22) Filed: Oct. 1, 2024

(30) Foreign Application Priority Data
Oct. 17, 2023 (KR) 10-2023-0138982

(51) Int. Cl. G09G 3/32

(52) U.S. Cl. CPC G09G 3/32; G09G 2300/0819; G09G 2300/0852; G09G 2300/0861; G09G 2310/08; G09G 2320/0233; G09G 2320/045; G09G 2330/021

(57) ABSTRACT

A pixel includes a light-emitting element, a pulse width modulator controlling an emission time duration of the light-emitting element based on a data voltage, and a constant current generator providing a driving current having a constant level to the light-emitting element based on a constant current generation voltage. The pulse width modulator includes a first driving transistor, and an N-type transistor connected to a gate electrode, a first electrode and a second electrode of the first driving transistor. The constant current generator includes a second driving transistor, and an N-type transistor connected to a gate electrode, a first electrode and a second electrode of the second driving transistor.

This application claims priority to Korean Patent Application No. 10-2023-0138982, filed on Oct. 17, 2023, and all the benefits accruing therefrom under 35 U.S.C. § 119, the content of which in its entirety is herein incorporated by reference.

### BACKGROUND

### 1. Field

Embodiments relate to a display device. More particularly, embodiments relate to a pixel driven by a pulse width modulation scheme and a display device including the pixel.

### 2. Description of the Related Art

A display device may include a plurality of pixels, and each of the pixels may include a self-luminous element. The self-luminous element may include an organic light-emitting diode, a quantum dot light-emitting diode, a micro-light-emitting diode, and the like.

In general, the organic light-emitting diode may be driven by a pulse amplitude modulation (“PAM”) scheme of controlling a luminance of a light emitted from the pixel by controlling a magnitude of a driving current flowing through the organic light-emitting diode.

When the micro-light-emitting diode is driven by the pulse amplitude modulation scheme, a wavelength of a light emitted from the micro-light-emitting diode may be shifted according to a magnitude of a driving current flowing through the micro-light-emitting diode. Accordingly, the micro-light-emitting diode may be driven by a pulse width modulation (“PWM”) scheme of controlling a luminance of a light emitted from the pixel by controlling an emission time duration of the micro-light-emitting diode while maintaining the magnitude of the driving current flowing through the micro-light-emitting diode constant.

### SUMMARY

Embodiments provide a pixel with relatively low power consumption and a display device including the pixel.

Embodiments provide a pixel in which a leakage current of a light-emitting element is reduced and a display device including the pixel.

A pixel in an embodiment includes a light-emitting element including a first electrode, and a second electrode connected to a low power line which transmits a low power voltage, a pulse width modulator which controls an emission time duration of the light-emitting element based on a data voltage, and a constant current generator which provides a driving current having a constant level to the light-emitting element based on a constant current generation voltage. The pulse width modulator includes a first driving transistor including a gate electrode connected to a first node, a first electrode connected to a second node and a second electrode connected to a third node, and an N-type transistor connected to the gate electrode, the first electrode and the second electrode of the first driving transistor. The constant current generator includes a second driving transistor including a gate electrode connected to a fourth node, a first electrode connected to a fifth node and a second electrode connected to a sixth node, and an N-type transistor connected to the gate electrode, the first electrode and the second electrode of the second driving transistor.

In an embodiment, the pulse width modulator may further include a first write transistor including a gate electrode which receives a scan signal, a first electrode connected to a data line which transmits the data voltage, and a second electrode connected to the second node, a first compensation transistor including a gate electrode which receives the scan signal, a first electrode connected to the third node, and a second electrode connected to the first node, a first emission control transistor including a gate electrode which receives an emission control signal, a first electrode which receives a first high power voltage, and a second electrode connected to the second node, a second emission control transistor including a gate electrode which receives the emission control signal, a first electrode connected to the third node, and a second electrode connected to the fourth node, a first initialization transistor including a gate electrode which receives a first initialization gate signal, a first electrode which receives a first initialization voltage, and a second electrode connected to the first node, and a first capacitor including a first electrode which receives a sweep signal, and a second electrode connected to the first node.

In an embodiment, the first driving transistor may be a P-type transistor, and each of the first write transistor and the first compensation transistor may be an N-type transistor.

In an embodiment, the first initialization transistor may be an N-type transistor.

In an embodiment, each of the first emission control transistor and the second emission control transistor may be an N-type transistor.

In an embodiment, the constant current generator may further include a second write transistor including a gate electrode which receives a constant current generation scan signal, a first electrode connected to the data line which transmits the constant current generation voltage, and a second electrode connected to the fifth node, a second compensation transistor including a gate electrode which receives the constant current generation scan signal, a first electrode connected to the sixth node, and a second electrode connected to the fourth node, a third emission control transistor including a gate electrode which receives the emission control signal, a first electrode which receives a second high power voltage, and a second electrode connected to the fifth node, a fourth emission control transistor including a gate electrode which receives the emission control signal, a first electrode connected to the sixth node, and a second electrode connected to the first electrode of the light-emitting element, a second initialization transistor including a gate electrode which receives a second initialization gate signal, a first electrode which receives the first initialization voltage, and a second electrode connected to the fourth node, a bypass transistor including a gate electrode which receives a bypass gate signal, a first electrode connected to a second initialization voltage line which transmits a second initialization voltage, and a second electrode connected to the first electrode of the light-emitting element, and a second capacitor including a first electrode which receives the second high power voltage, and a second electrode connected to the fourth node.

In an embodiment, the second driving transistor may be a P-type transistor, and each of the second write transistor and the second compensation transistor may be an N-type transistor.

In an embodiment, the second initialization transistor may be an N-type transistor.

In an embodiment, each of the third emission control transistor and the fourth emission control transistor may be an N-type transistor.

In an embodiment, the bypass transistor may be an N-type transistor.

In an embodiment, the second initialization voltage line may be separated from the low power line.

In an embodiment, a voltage level of the second initialization voltage may be higher than or equal to a voltage level of the low power voltage.

In an embodiment, a voltage level of the first high power voltage may be higher than a voltage level of the second high power voltage.

In an embodiment, one frame may include a display scan period in which the data voltage is written and a self scan period in which the data voltage is not written. The second initialization gate signal may have a turn-on voltage level in a first initialization period within the display scan period and a second initialization period within the self scan period.

In an embodiment, the first initialization gate signal may have a turn-on voltage level in the first initialization period, and have a turn-off voltage level in the second initialization period.

A pixel in an embodiment includes a light-emitting element including a first electrode, and a second electrode connected to a low power line which transmits a low power voltage, a pulse width modulator which controls an emission time duration of the light-emitting element based on a data voltage, and a constant current generator which provides a driving current having a constant level to the light-emitting element based on a constant current generation voltage. The constant current generator includes a bypass transistor including a gate electrode which receives a bypass gate signal, a first electrode connected to a second initialization voltage line which transmits a second initialization voltage and separated from the low power line, and a second electrode connected to the first electrode of the light-emitting element.

In an embodiment, a voltage level of the second initialization voltage may be higher than or equal to a voltage level of the low power voltage.

In an embodiment, the pulse width modulator may include a first driving transistor including a gate electrode connected to a first node, a first electrode connected to a second node, and a second electrode connected to a third node, a first write transistor including a gate electrode which receives a scan signal, a first electrode connected to a data line which transmits the data voltage, and a second electrode connected to the second node, a first compensation transistor including a gate electrode which receives the scan signal, a first electrode connected to the third node, and a second electrode connected to the first node, a first emission control transistor including a gate electrode which receives an emission control signal, a first electrode which receives a first high power voltage, and a second electrode connected to the second node, a second emission control transistor including a gate electrode which receives the emission control signal, a first electrode connected to the third node, and a second electrode connected to a fourth node, a first initialization transistor including a gate electrode which receives a first initialization gate signal, a first electrode which receives a first initialization voltage, and a second electrode connected to the first node, and a first capacitor including a first electrode which receives a sweep signal, and a second electrode connected to the first node.

In an embodiment, the first driving transistor may be a P-type transistor, and at least one of the first write transistor, the first compensation transistor, and the first initialization transistor may be an N-type transistor.

In an embodiment, the constant current generator may further include a second driving transistor including a gate electrode connected to the fourth node, a first electrode connected to a fifth node and a second electrode connected to a sixth node, a second write transistor including a gate electrode which receives a constant current generation scan signal, a first electrode connected to the data line which transmits the constant current generation voltage, and a second electrode connected to the fifth node, a second compensation transistor including a gate electrode which receives the constant current generation scan signal, a first electrode connected to the sixth node, and a second electrode connected to the fourth node, a third emission control transistor including a gate electrode which receives the emission control signal, a first electrode which receives a second high power voltage, and a second electrode connected to the fifth node, a fourth emission control transistor including a gate electrode which receives the emission control signal, a first electrode connected to the sixth node, and a second electrode connected to the first electrode of the light-emitting element, a second initialization transistor including a gate electrode which receives a second initialization gate signal, a first electrode which receives the first initialization voltage, and a second electrode connected to the fourth node, and a second capacitor including a first electrode which receives the second high power voltage, and a second electrode connected to the fourth node.

In an embodiment, the second driving transistor may be a P-type transistor, and at least one of the second write transistor, the second compensation transistor, and the second initialization transistor may be an N-type transistor.

In an embodiment, a voltage level of the first high power voltage may be higher than a voltage level of the second high power voltage.

A display device in an embodiment includes a display panel including a plurality of pixels, a scan driver which sequentially provides scan signals to the plurality of pixels, and a data driver which provides a data voltage and a constant current generation voltage to each of the plurality of pixels. Each of the plurality of pixels includes a light-emitting element including a first electrode, and a second electrode connected to a low power line which transmits a low power voltage, a pulse width modulator which controls an emission time duration of the light-emitting element based on the data voltage, and a constant current generator which provides a driving current having a constant level to the light-emitting element based on the constant current generation voltage. The pulse width modulator includes a first driving transistor including a gate electrode connected to a first node, a first electrode connected to a second node and a second electrode connected to a third node, and an N-type transistor connected to the gate electrode, the first electrode and the second electrode of the first driving transistor. The constant current generator includes a second driving transistor including a gate electrode connected to a fourth node, a first electrode connected to a fifth node and a second electrode connected to a sixth node, and an N-type transistor connected to the gate electrode, the first electrode and the second electrode of the second driving transistor.

In an embodiment, the pulse width modulator may further include a first write transistor including a gate electrode which receives a scan signal of the scan signals, a first electrode connected to a data line which transmits the data voltage, and a second electrode connected to the second node, a first compensation transistor including a gate electrode which receives the scan signal, a first electrode connected to the third node, and a second electrode connected to the first node, a first emission control transistor including a gate electrode which receives an emission control signal, a first electrode which receives a first high power voltage, and a second electrode connected to the second node, a second emission control transistor including a gate electrode which receives the emission control signal, a first electrode connected to the third node, and a second electrode connected to the fourth node, a first initialization transistor including a gate electrode which receives a first initialization gate signal, a first electrode which receives a first initialization voltage, and a second electrode connected to the first node, and a first capacitor including a first electrode which receives a sweep signal, and a second electrode connected to the first node.

In an embodiment, the constant current generator may further include a second write transistor including a gate electrode which receives a constant current generation scan signal, a first electrode connected to the data line which transmits the constant current generation voltage, and a second electrode connected to the fifth node, a second compensation transistor including a gate electrode which receives the constant current generation scan signal, a first electrode connected to the sixth node, and a second electrode connected to the fourth node, a third emission control transistor including a gate electrode which receives the emission control signal, a first electrode which receives a second high power voltage, and a second electrode connected to the fifth node, a fourth emission control transistor including a gate electrode which receives the emission control signal, a first electrode connected to the sixth node, and a second electrode connected to the first electrode of the light-emitting element, a second initialization transistor including a gate electrode which receives a second initialization gate signal, a first electrode which receives the first initialization voltage, and a second electrode connected to the fourth node, a bypass transistor including a gate electrode which receives a bypass gate signal, a first electrode connected to a second initialization voltage line which transmits a second initialization voltage, and a second electrode connected to the first electrode of the light-emitting element, and a second capacitor including a first electrode which receives the second high power voltage, and a second electrode connected to the fourth node.

In an embodiment, the second initialization voltage line may be separated from the low power line.

The pixel in the embodiments may include an N-type transistor connected to an electrode of a driving transistor, so that power consumption of the pixel may be reduced.

In the pixel in the embodiments, a second initialization voltage line connected to a first electrode of a bypass transistor may be separated from a low power line connected to a second electrode of a light-emitting element, so that a leakage current of the light-emitting element may be reduced.

### BRIEF DESCRIPTION OF THE DRAWINGS

Illustrative, non-limiting embodiments will be more clearly understood from the following detailed description taken in conjunction with the accompanying drawings.

FIG. 1 is a block diagram showing an embodiment of a display device.

FIG. 2 is a view for describing a variable frequency driving of the display device of FIG. 1.

FIG. 3 is a circuit diagram showing an embodiment of a pixel included in the display device of FIG. 1.

FIG. 4 is a view showing an embodiment of signals and voltages provided to pixels included in the display device of FIG. 1 in a display scan period.

FIGS. 5 to 10 are views for describing an operation of the pixel of FIG. 3 in the display scan period.

FIG. 11 is a view showing an embodiment of signals and voltages provided to pixels included in the display device of FIG. 1 in a self scan period.

FIGS. 12 to 16 are views for describing an operation of the pixel of FIG. 3 in the self scan period.

FIG. 17 is a circuit diagram showing another embodiment of a pixel included in the display device of FIG. 1.

FIG. 18 is a view showing another embodiment of signals and voltages provided to pixels included in the display device of FIG. 1 in the display scan period.

FIG. 19 is a view showing another embodiment of signals and voltages provided to pixels included in the display device of FIG. 1 in the self scan period.

FIG. 20 is a circuit diagram showing another embodiment of a pixel included in the display device of FIG. 1.

FIG. 21 is a view showing another embodiment of signals and voltages provided to pixels included in the display device of FIG. 1 in the display scan period.

FIG. 22 is a view showing another embodiment of signals and voltages provided to pixels included in the display device of FIG. 1 in the self scan period.

FIG. 23 is a circuit diagram showing another embodiment of a pixel included in the display device of FIG. 1.

FIG. 24 is a block diagram showing an embodiment of a display device.

FIG. 25 is a circuit diagram showing an embodiment of a pixel included in the display device of FIG. 24.

FIG. 26 is a view showing another embodiment of signals and voltages provided to pixels included in the display device of FIG. 24 in a frame.

FIG. 27 is a block diagram showing a display device.

FIG. 28 is a circuit diagram showing an embodiment of a pixel included in the display device of FIG. 27.

FIG. 29 is a view showing an embodiment of signals and voltages provided to pixels included in the display device of FIG. 27 in the display scan period.

FIG. 30 is a view showing an embodiment of signals and voltages provided to pixels included in the display device of FIG. 27 in the self scan period.

FIG. 31 is a block diagram showing an embodiment of a display device.

FIG. 32 is a circuit diagram showing an embodiment of a pixel included in the display device of FIG. 31.

FIG. 33 is a view showing an embodiment of signals and voltages provided to the pixel of FIG. 32 in the display scan period.

FIG. 34 is a view showing an embodiment of signals and voltages provided to the pixel of FIG. 32 in the self scan period.

FIG. 35 is a block diagram showing an embodiment of an electronic device.

FIG. 36 is a view showing an embodiment in which the electronic device of FIG. 35 is implemented as a smart watch.

### DETAILED DESCRIPTION

Hereinafter, a pixel and a display device in embodiments of the disclosure will be described in more detail with reference to the accompanying drawings. The same or similar reference numerals will be used for the same elements in the accompanying drawings.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” can mean within one or more standard deviations, or within ±30%, 20%, 10%, 5% of the stated value, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

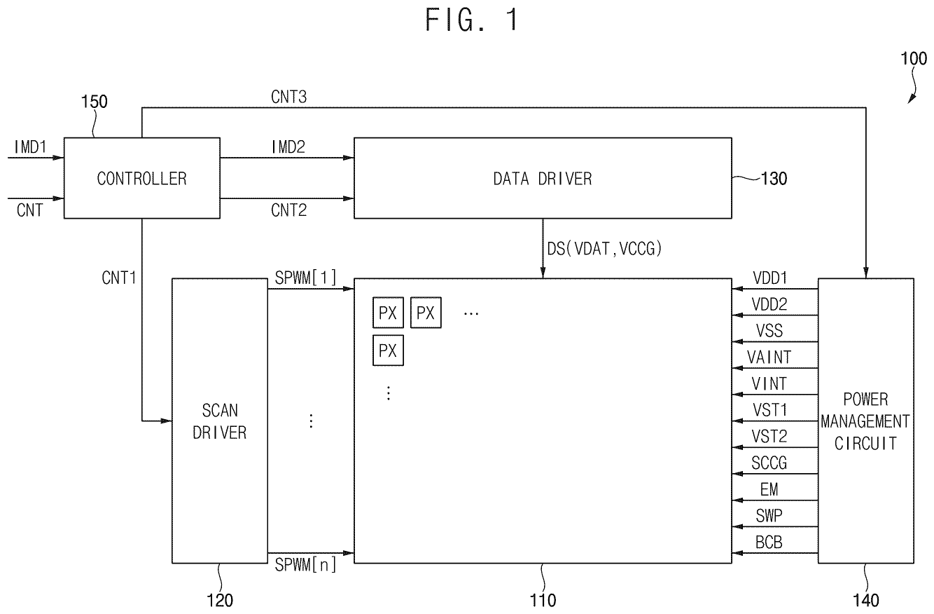

FIG. 1 is a block diagram showing an embodiment of a display device 100.

Referring to FIG. 1, a display device 100 may include a display panel 110, a scan driver 120, a data driver 130, a power management circuit 140, and a controller 150.

The display panel 110 may include pixels PX. In an embodiment, the pixels PX may include a first pixel which emits a light having a first color, a second pixel which emits a light having a second color, and a third pixel which emits a light having a third color. In an embodiment, the first color, the second color, and the third color may be red, green, and blue, respectively, for example.

The scan driver 120 may sequentially provide first to n^{th} scan signals SPWM[1] to SPWM[n] (where n is a natural number that is greater than 1) to the pixels PX. The scan driver 120 may sequentially generate the first to n^{th} scan signals SPWM[1] to SPWM[n] corresponding to first to n^{th} pixel rows, respectively, based on a first control signal CNT1. The first control signal CNT1 may include a scan clock signal, a scan start signal, or the like.

The data driver 130 may provide data signals DS to the pixels PX. The data signal DS may include a data voltage VDAT and a constant current generation voltage VCCG. The data driver 130 may generate the data signals DS corresponding to pixel columns, respectively, based on second image data IMD2 and a second control signal CNT2. In an embodiment, the second image data IMD2 may include gray level values corresponding to the pixels PX, respectively. The second control signal CNT2 may include a data clock signal, a horizontal start signal, a load signal, or the like.

The power management circuit 140 may commonly provide a first high power voltage VDD1, a second high power voltage VDD2, a low power voltage VSS, a second initialization voltage VAINT, a first initialization voltage VINT, a first initialization gate signal VST1, a second initialization gate signal VST2, a constant current generation scan signal SCCG, an emission control signal EM, a sweep signal SWP, and a bypass gate signal BCB to the pixels PX. The power management circuit 140 may generate the first high power voltage VDD1, the second high power voltage VDD2, the low power voltage VSS, the second initialization voltage VAINT, the first initialization voltage VINT, the first initialization gate signal VST1, the second initialization gate signal VST2, the constant current generation scan signal SCCG, the emission control signal EM, the sweep signal SWP, and the bypass gate signal BCB based on a third control signal CNT3.

The controller 150 may control an operation (or driving) of the scan driver 120, an operation (or driving) of the data driver 130, and an operation (or driving) of the power management circuit 140. The controller 150 may generate the first control signal CNT1, the second image data IMD2, the second control signal CNT2, and the third control signal CNT3 based on first image data IMD1 and a control signal CNT. In an embodiment, the first image data IMD1 may include gray level values corresponding to the pixels PX, respectively. The controller 150 may convert the first image data IMD1 into the second image data IMD2. The control signal CNT may include a master clock signal, a vertical synchronization signal, a horizontal synchronization signal, a data enable signal, or the like.

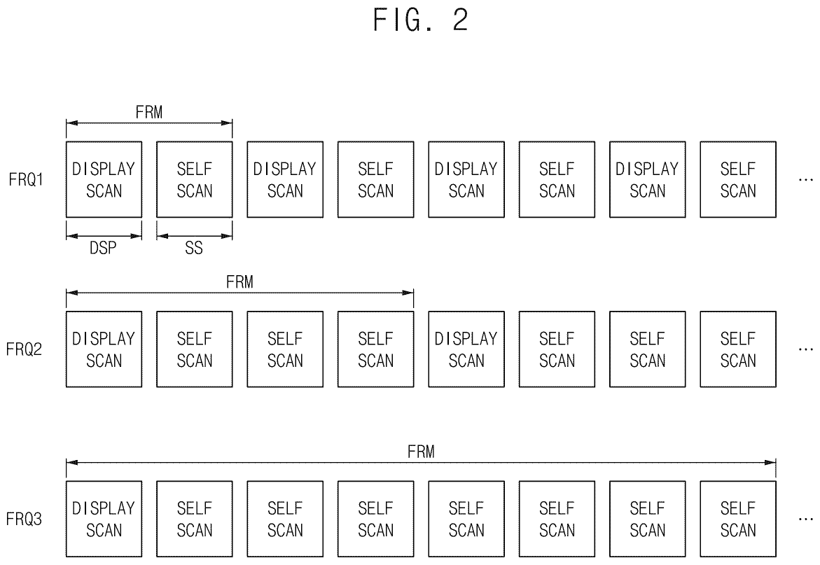

FIG. 2 is a view for describing a variable frequency driving of the display device 100 of FIG. 1.

Referring to FIGS. 1 and 2, the display device 100 may display an image by a variable frequency driving scheme which is capable of changing a driving frequency. The driving frequency may represent a frequency at which an image is displayed from the display device 100 (in other words, the number of frames FRM) for one second.

Each of the frames FRM of the display device 100 may include a display scan period DSP and at least one self scan period SS. In the display scan period DSP, the data voltage VDAT may be written to the pixel PX, and the pixel PX may emit light for a time duration corresponding to the written data voltage VDAT. In the self scan period SS, the data voltage VDAT may not be written to the pixel PX, and the pixel PX may emit light for a time duration corresponding to the data voltage VDAT written in the display scan period DSP.

In an embodiment, a length of the display scan period DSP and a length of the self scan period SS may be substantially equal to each other. However, the number of self scan periods SS included in the frame FRM may be determined according to the driving frequency. In an embodiment, the number of self scan periods SS included in the frame FRM may increase when the driving frequency decreases.

When the display device 100 is driven at a first frequency FRQ1 (e.g., about 120 hertz (Hz)), the frame FRM may include one display scan period DSP and one self scan period SS. When the display device 100 is driven at a second frequency FRQ2 (e.g., about 60 Hz) which is less than the first frequency FRQ1, the frame FRM may include one display scan period DSP and three consecutive self scan periods SS. When the display device 100 is driven at a third frequency FRQ3 (e.g., about 30 Hz) which is less than the second frequency FRQ2, the frame FRM may include one display scan period DSP and seven consecutive self scan periods SS.

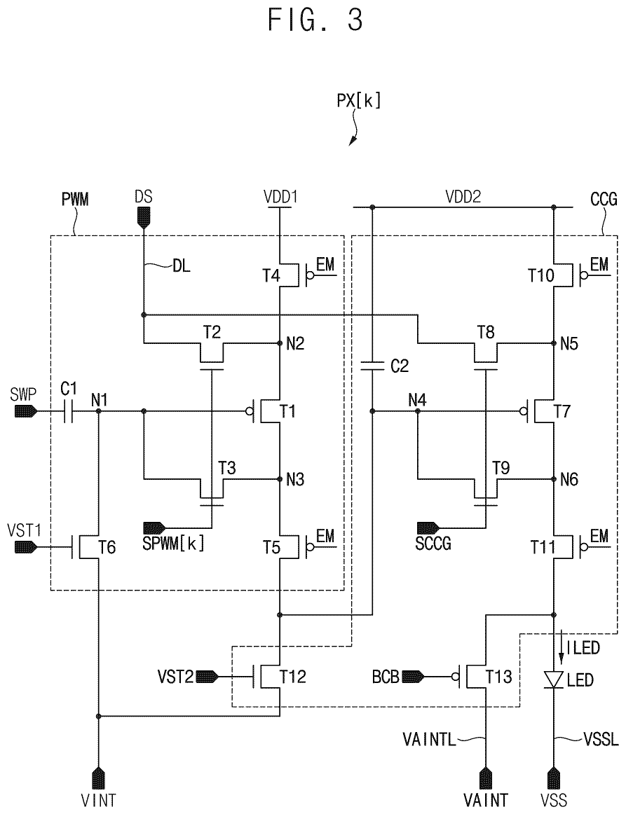

FIG. 3 is a circuit diagram showing an embodiment of a pixel PX[k] included in the display device 100 of FIG. 1. FIG. 3 may show a pixel PX[k] included in a kth pixel row (where k is a natural number that is greater than or equal to 1, and less than or equal to n).

Referring to FIGS. 1 and 3, the pixel PX[k] may include a light-emitting element LED, a pulse width modulator PWM, and a constant current generator CCG. The light-emitting element LED may emit a light based on a driving current ILED. The light-emitting element LED may include a first electrode, and a second electrode connected to a low power line VSSL which transmits the low power voltage VSS.

In an embodiment, the light-emitting element LED may be a micro-light-emitting diode (“μLED”). The micro-light-emitting diode may refer to an ultra-small light-emitting diode having a size of about 100 micrometers (μm) or less.

The pulse width modulator PWM may control an emission time duration of the light-emitting element LED based on the data voltage VDAT. The pulse width modulator PWM may include a first driving transistor T1 (hereinafter also referred to as a “first transistor”) and at least one N-type transistor (e.g., n-channel metal-oxide-semiconductor (“NMOS”) transistor) connected to an electrode of the first transistor T1. Compared to P-type transistor (e.g., p-channel metal-oxide-semiconductor (“PMOS”) transistor), N-type transistor may have a relatively small drain-source voltage, and may have a relatively small off-current. The pulse width modulator PWM may include at least one N-type transistor connected to an electrode of the first transistor T1, so that power consumption of the pixel PX[k] may be reduced.

In an embodiment, the pulse width modulator PWM may include the first transistor T1, a first write transistor T2 (hereinafter also referred to as a “second transistor”), a first compensation transistor T3 (hereinafter also referred to as a “third transistor”), a first emission control transistor T4 (hereinafter also referred to as a “fourth transistor”), a second emission control transistor T5 (hereinafter also referred to as a “fifth transistor”), a first initialization transistor T6 (hereinafter also referred to as a “sixth transistor”), and a first capacitor C1.

The constant current generator CCG may provide the driving current ILED having a constant level to the light-emitting element LED based on the constant current generation voltage VCCG. The constant current generator CCG may include a second driving transistor T7 (hereinafter also referred to as a “seventh transistor”) and at least one N-type transistor connected to an electrode of the seventh transistor T7. The constant current generator CCG may include at least one N-type transistor connected to an electrode of the seventh transistor T7, so that power consumption of the pixel PX[k] may be reduced.

In an embodiment, the constant current generator CCG may include the seventh transistor T7, a second write transistor T8 (hereinafter also referred to as an “eighth transistor”), a second compensation transistor T9 (hereinafter also referred to as a “ninth transistor”), a third emission control transistor T10 (hereinafter also referred to as a “10^{th} transistor”), a fourth emission control transistor T11 (hereinafter also referred to as an “11^{th} transistor”), a second initialization transistor T12 (hereinafter also referred to as a “12^{th} transistor”), a bypass transistor T13 (hereinafter also referred to as a “13^{th} transistor”), and a second capacitor C2.

The first transistor T1 may include a gate electrode connected to a first node N1, a first electrode connected to a second node N2, and a second electrode connected to a third node N3. The first transistor T1 may be turned on based on a voltage difference between the second node N2 and the first node N1.

The second transistor T2 may include a gate electrode which receives a scan signal SPWM[k] corresponding to the pixel PX[k], a first electrode connected to a data line DL which transmits the data signal DS, and a second electrode connected to the second node N2. The second transistor T2 may transmit the data voltage VDAT to the second node N2 in response to the scan signal SPWM[k] having a turn-on voltage level.

The third transistor T3 may include a gate electrode which receives the scan signal SPWM[k], a first electrode connected to the third node N3, and a second electrode connected to the first node N1. The third transistor T3 may connect the third node N3 to the first node N1 in response to the scan signal SPWM[k] having the turn-on voltage level. In other words, the third transistor T3 may diode-connect the first transistor T1 in response to the scan signal SPWM[k] having the turn-on voltage level.

The fourth transistor T4 may include a gate electrode which receives the emission control signal EM, a first electrode which receives the first high power voltage VDD1, and a second electrode connected to the second node N2. The fourth transistor T4 may transmit the first high power voltage VDD1 to the second node N2 in response to the emission control signal EM having a turn-on voltage level.

The fifth transistor T5 may include a gate electrode which receives the emission control signal EM, a first electrode connected to the third node N3, and a second electrode connected to a fourth node N4. The fifth transistor T5 may connect the third node N3 to the fourth node N4 in response to the emission control signal EM having the turn-on voltage level.

The sixth transistor T6 may include a gate electrode which receives the first initialization gate signal VST1, a first electrode which receives the first initialization voltage VINT, and a second electrode connected to the first node N1. The sixth transistor T6 may transmit the first initialization voltage VINT to the first node N1 in response to the first initialization gate signal VST1 having a turn-on voltage level.

The seventh transistor T7 may include a gate electrode connected to the fourth node N4, a first electrode connected to a fifth node N5, and a second electrode connected to a sixth node N6. The seventh transistor T7 may generate the driving current ILED corresponding to a voltage difference between the fifth node N5 and the fourth node N4.

The eighth transistor T8 may include a gate electrode which receives the constant current generation scan signal SCCG, a first electrode connected to the data line DL, and a second electrode connected to the fifth node N5. The eighth transistor T8 may transmit the constant current generation voltage VCCG to the fifth node N5 in response to the constant current generation scan signal SCCG having a turn-on voltage level.

The ninth transistor T9 may include a gate electrode which receives the constant current generation scan signal SCCG, a first electrode connected to the sixth node N6, and a second electrode connected to the fourth node N4. The ninth transistor T9 may connect the sixth node N6 to the fourth node N4 in response to the constant current generation scan signal SCCG having the turn-on voltage level. In other words, the ninth transistor T9 may diode-connect the seventh transistor T7 in response to the constant current generation scan signal SCCG having the turn-on voltage level.

The 10^{th} transistor T10 may include a gate electrode which receives the emission control signal EM, a first electrode which receives the second high power voltage VDD2, and a second electrode connected to the fifth node N5. The 10^{th} transistor T10 may transmit the second high power voltage VDD2 to the fifth node N5 in response to the emission control signal EM having the turn-on voltage level.

The 11^{th} transistor T11 may include a gate electrode which receives the emission control signal EM, a first electrode connected to the sixth node N6, and a second electrode connected to the first electrode of the light-emitting element LED. The 11^{th} transistor T11 may connect the sixth node N6 to the first electrode of the light-emitting element LED in response to the emission control signal EM having the turn-on voltage level.

The 12^{th} transistor T12 may include a gate electrode which receives the second initialization gate signal VST2, a first electrode which receives the first initialization voltage VINT, and a second electrode connected to the fourth node N4. The 12^{th} transistor T12 may transmit the first initialization voltage VINT to the fourth node N4 in response to the second initialization gate signal VST2 having a turn-on voltage level.

The 13^{th} transistor T13 may include a gate electrode which receives the bypass gate signal BCB, a first electrode connected to a second initialization voltage line VAINTL which transmits the second initialization voltage VAINT, and a second electrode connected to the first electrode of the light-emitting element LED. The 13^{th} transistor T13 may transmit the second initialization voltage VAINT to the first electrode of the light-emitting element LED in response to the bypass gate signal BCB having a turn-on voltage level.

The second initialization voltage line VAINTL may be separated from the low power line VSSL.

When the second initialization voltage line VAINTL is connected to the low power line VSSL (in other words, when the first electrode of the 13^{th} transistor T13 is connected to the second electrode of the light-emitting element LED), a leakage current flowing through the light-emitting element LED may increase as the light-emitting element LED and the 13^{th} transistor T13 are connected in parallel. The light-emitting element LED may unintentionally emit light due to the leakage current flowing through the light-emitting element LED, and a black display characteristics of the display device 100 may deteriorate when the display device 100 displays black.

In the illustrated embodiment, the second initialization voltage line VAINTL may be separated from the low power line VSSL, so that a current path from the first electrode of the light-emitting element LED to the second initialization voltage line VAINTL may be formed through the 13^{th} transistor T13, and accordingly, the leakage current flowing through the light-emitting element LED may be reduced. Accordingly, the black display characteristics of the display device 100 may be improved.

In an embodiment, each of the first transistor T1, the fourth transistor T4, the fifth transistor T5, the seventh transistor T7, the 10^{th} transistor T10, the 11^{th} transistor T11, and the 13^{th} transistor T13 may be a P-type transistor, and each of the second transistor T2, the third transistor T3, the sixth transistor T6, the eighth transistor T8, the ninth transistor T9, and the 12^{th} transistor T12 may be an N-type transistor. In an embodiment, each of the first transistor T1, the fourth transistor T4, the fifth transistor T5, the seventh transistor T7, the 10^{th} transistor T10, the 11^{th} transistor T11, and the 13^{th} transistor T13 may be a polycrystalline silicon transistor, and each of the second transistor T2, the third transistor T3, the sixth transistor T6, the eighth transistor T8, the ninth transistor T9, and the 12^{th} transistor T12 may be an oxide semiconductor transistor.

The first capacitor C1 may include a first electrode which receives the sweep signal SWP, and a second electrode connected to the first node N1. The first capacitor C1 may store a voltage of the first node N1.

The second capacitor C2 may include a first electrode which receives the second high power voltage VDD2, and a second electrode connected to the fourth node N4. The second capacitor C2 may store a voltage of the fourth node N4.

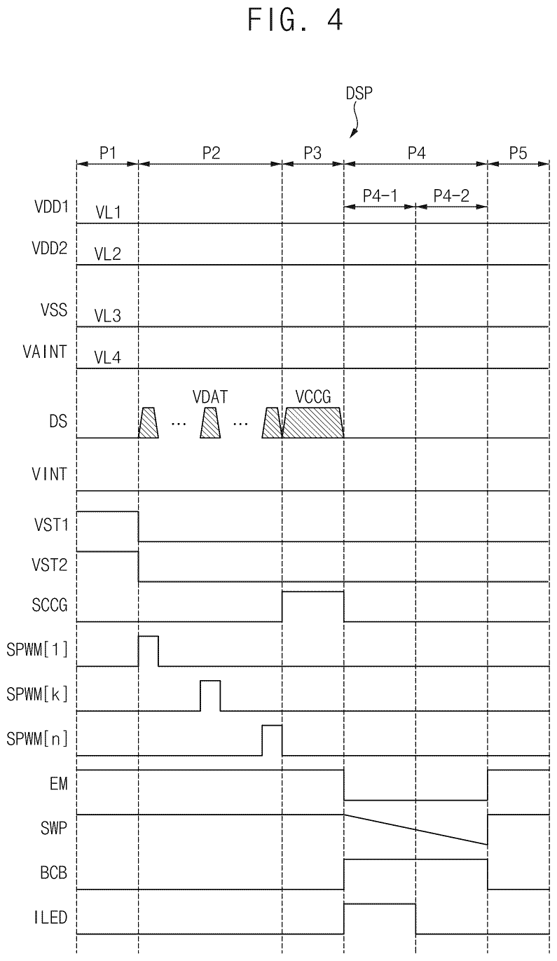

FIG. 4 is a view showing an embodiment of signals and voltages provided to pixels PX included in the display device 100 of FIG. 1 in the display scan period DSP.

Referring to FIGS. 1, 3, and 4, the display scan period DSP may include a first initialization period P1 (hereinafter also referred to as a “first period”) in which the gate electrode of the first transistor T1 and the gate electrode of the seventh transistor T7 are initialized, a first write period P2 (hereinafter also referred to as a “second period”) in which the data voltage VDAT for which a threshold voltage of the first transistor T1 is compensated is written to the gate electrode of the first transistor T1, a second write period P3 (hereinafter also referred to as a “third period”) in which the constant current generation voltage VCCG for which a threshold voltage of the seventh transistor T7 is compensated is written to the gate electrode of the seventh transistor T7, a first emission period P4 (hereinafter also referred to as a “fourth period”) in which the light-emitting element LED emits a light, and a first bypass period P5 (hereinafter also referred to as a “fifth period”) in which charges of the light-emitting element LED are discharged. The fourth period P4 may include a fourth-first period P4-1 in which the driving current ILED having the constant level flows through the light-emitting element LED, and a fourth-second period P4-2 in which the driving current ILED does not flow through the light-emitting element LED. The periods P1 to P3 and P5 except for the fourth period P4 in the display scan period DSP may be non-emission periods.

The first high power voltage VDD1, the second high power voltage VDD2, the low power voltage VSS, the second initialization voltage VAINT, the first initialization voltage VINT, the first initialization gate signal VST1, the second initialization gate signal VST2, the constant current generation scan signal SCCG, the emission control signal EM, the sweep signal SWP, and the bypass gate signal BCB may be commonly provided to the pixels PX. The scan signals SPWM[1], . . . , SPWM[k], . . . , and SPWM[n] may be sequentially provided to the pixels PX on a pixel row basis.

Each of the first high power voltage VDD1, the second high power voltage VDD2, the low power voltage VSS, the second initialization voltage VAINT, and the first initialization voltage VINT may be a constant voltage of which voltage level is constant. In an embodiment, a voltage level VL1 of the first high power voltage VDD1 is higher than a voltage level VL2 of the second high power voltage VDD2. In an embodiment, the voltage level VL1 of the first high power voltage VDD1 may be about 5.2 V, and the voltage level VL2 of the second high power voltage VDD2 may be about 4.6 V, for example. In an embodiment, a voltage level VL4 of the second initialization voltage VAINT is higher than or equal to a voltage level VL3 of the low power voltage VSS. In an embodiment, the voltage level VL3 of the low power voltage VSS may be about −5 V, and the voltage level VL4 of the second initialization voltage VAINT may be about −4 V to about −5 V, for example.

The data signal DS may have the data voltage VDAT in the second period P2, and have the constant current generation voltage VCCG in the third period P3.

Each of the first initialization gate signal VST1 and the second initialization gate signal VST2 may have a turn-on voltage level (e.g., logic relatively high level) in the first period P1, and have a turn-off voltage level (e.g., logic relatively low level) in the second to fifth periods P2 to P5.

The constant current generation scan signal SCCG may have a turn-on voltage level (e.g., logic relatively high level) in the third period P3, and have a turn-off voltage level (e.g., logic relatively low level) in the first, second, fourth, and fifth periods P1, P2, P4, and P5.

Each of the scan signals SPWM[1], . . . , SPWM[k], . . . , and SPWM[n] may have a turn-on voltage level (e.g., logic relatively high level) in the second period P2, and have a turn-off voltage level (e.g., logic relatively low level) in the first and third to fifth periods P1 and P3 to P5. The scan signals SPWM[1], . . . , SPWM[k], . . . , and SPWM[n] may be sequentially shifted by a predetermined time duration (e.g., one horizontal time).

The emission control signal EM may have a turn-on voltage level (e.g., logic relatively low level) in the fourth period P4, and have a turn-off voltage level (e.g., logic relatively high level) in the first to third and fifth periods P1 to P3 and P5.

The sweep signal SWP may have a relatively high voltage level in the first to third and fifth periods P1 to P3 and P5, and linearly decrease from the relatively high voltage level to a relatively low voltage level in the fourth period P4.

The bypass gate signal BCB may have a turn-on voltage level (e.g., logic relatively low level) in the first to third and fifth periods P1 to P3 and P5, and have a turn-off voltage level (e.g., logic relatively high level) in the fourth period P4.

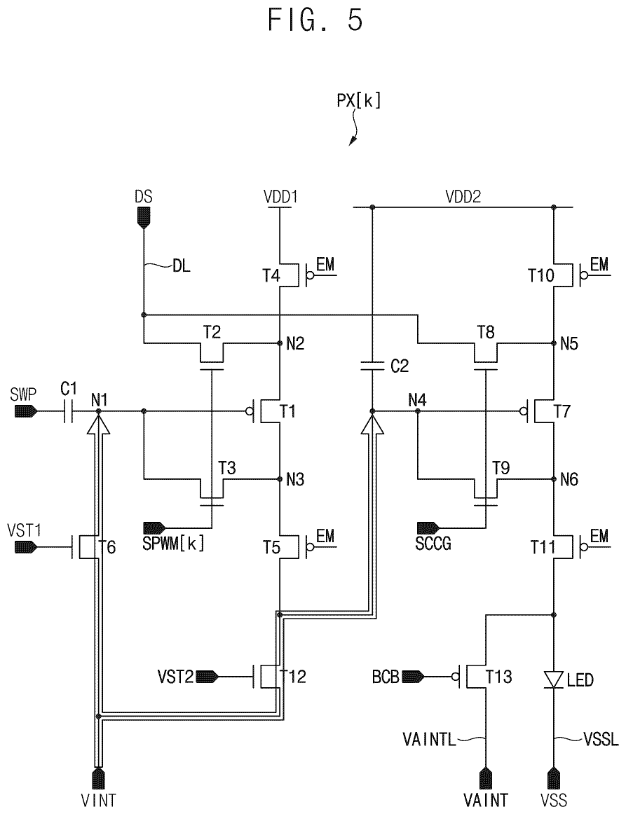

FIGS. 5 to 10 are views for describing an operation of the pixel PX[k] of FIG. 3 in the display scan period DSP.

Referring to FIGS. 4 and 5, in the first period P1, the sixth transistor T6 may be turned on in response to the first initialization gate signal VST1 having the turn-on voltage level, and the 12^{th} transistor T12 may be turned on in response to the second initialization gate signal VST2 having the turn-on voltage level. Accordingly, the first initialization voltage VINT may be applied to the first node N1 through the sixth transistor T6, the first initialization voltage VINT may be applied to the fourth node N4 through the 12^{th} transistor T12, and the gate electrode of the first transistor T1 and the gate electrode of the seventh transistor T7 may be initialized.

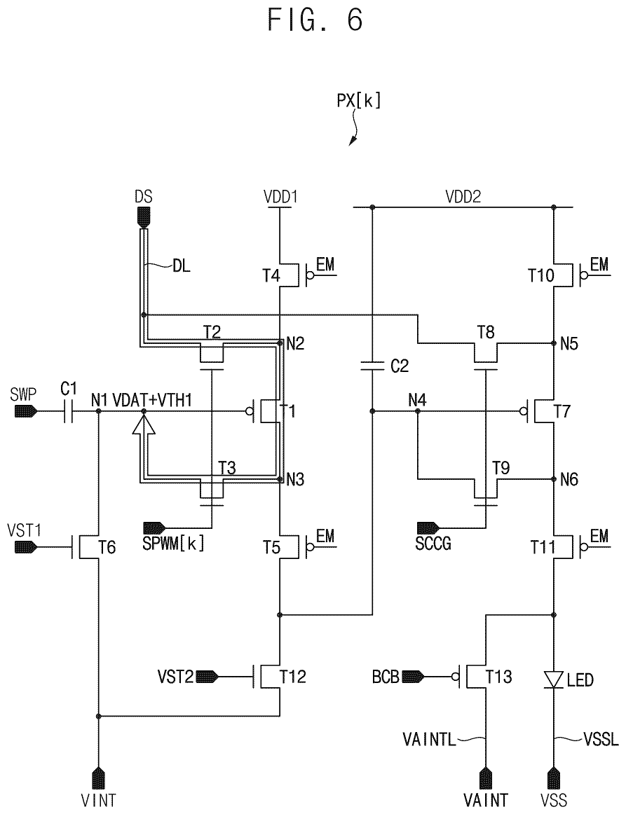

Referring to FIGS. 4 and 6, in the second period P2, the second transistor T2 and the third transistor T3 may be turned on in response to the scan signal SPWM[k] having the turn-on voltage level. Accordingly, the data voltage VDAT for which the threshold voltage VTH1 of the first transistor T1 is compensated may be applied to the first node N1 through the second transistor T2, the first transistor T1, and the third transistor T3.

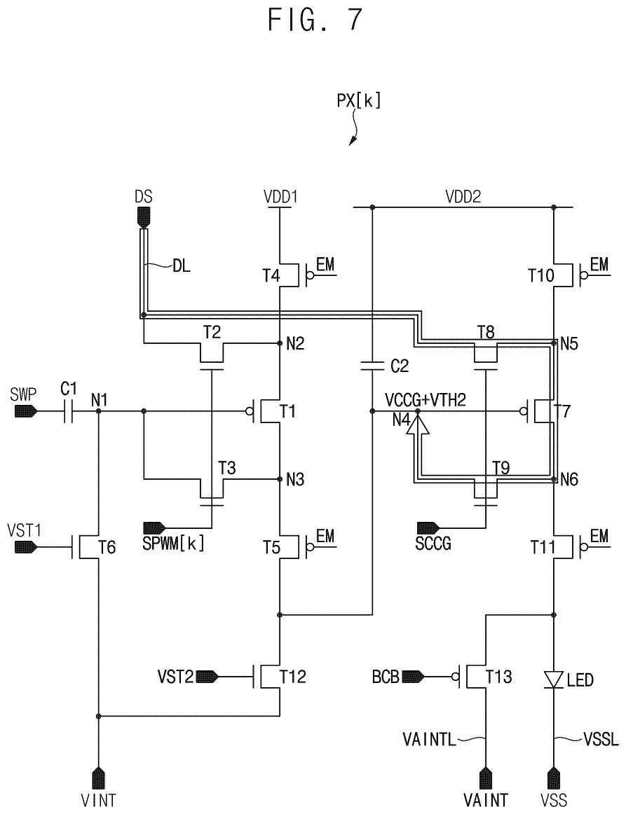

Referring to FIGS. 4 and 7, in the third period P3, the eighth transistor T8 and the ninth transistor T9 may be turned on in response to the constant current generation scan signal SCCG having the turn-on voltage level. Accordingly, the constant current generation voltage VCCG for which the threshold voltage VTH2 of the seventh transistor T7 is compensated may be applied to the fourth node N4 through the eighth transistor T8, the seventh transistor T7, and the ninth transistor T9.

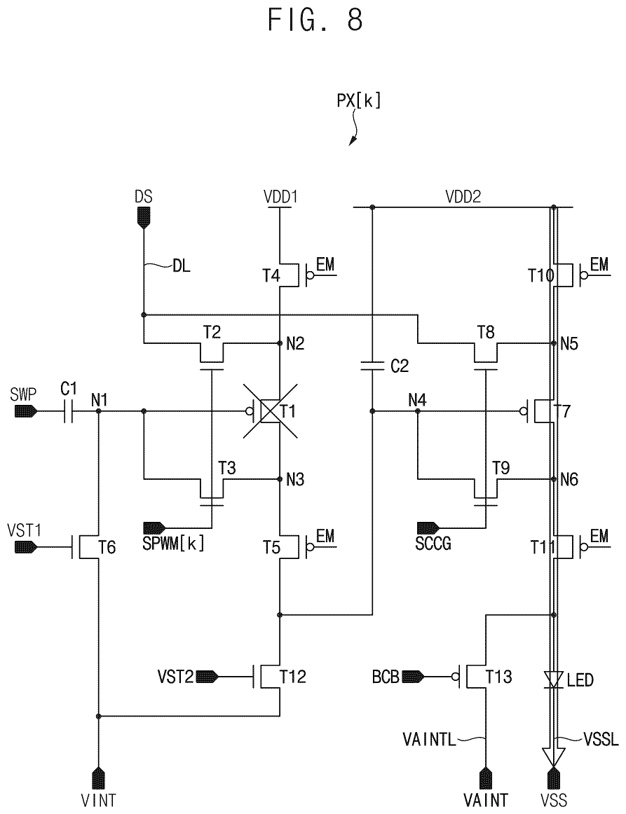

Referring to FIGS. 4 and 8, in the fourth-first period P4-1, the seventh transistor T7 may generate the driving current ILED having the constant level corresponding to a voltage difference between the first electrode and the gate electrode of the seventh transistor T7 (i.e., the voltage difference between the fifth node N5 and the fourth node N4), and the light-emitting element LED may emit the light with a luminance corresponding to the driving current ILED. In the fourth period P4, the sweep signal SWP may linearly decrease from the relatively high voltage level to the relatively low voltage level, and the emission control signal EM may have the turn-on voltage level. Accordingly, the voltage of the first node N1 may change in response to the change in the sweep signal SWP caused by a coupling effect of the first capacitor C1, and the first high power voltage VDD1 may be applied to the second node N2. Accordingly, in the fourth-first period P4-1, a voltage difference between the first electrode and the gate electrode of the first transistor T1 (i.e., the difference between the first high power voltage VDD1 and the voltage of the first node N1) may be less than the threshold voltage VTH1 of the first transistor T1, so that the first transistor T1 may be turned off.

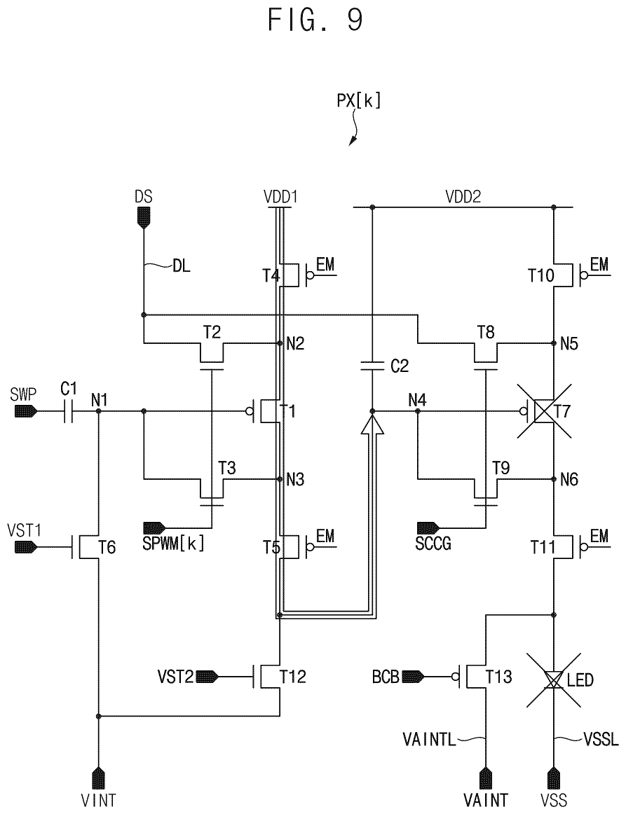

Referring to FIGS. 4 and 9, in the fourth-second period P4-2, since the sweep signal SWP linearly decreases by the coupling effect of the first capacitor C1, the voltage of the first node N1 may be continuously decreased. Accordingly, the voltage difference between the first electrode and the gate electrode of the first transistor T1 (i.e., the difference between the first high power voltage VDD1 and the voltage of the first node N1) may be greater than the threshold voltage VTH1 of the first transistor T1, and the first transistor T1 may be turned on. The first high power voltage VDD1 may be applied to the fourth node N4 through the fourth transistor T4, the first transistor T1, and the fifth transistor T5, and the seventh transistor T7 may be turned off. Accordingly, the seventh transistor T7 may stop generating the driving current ILED, and the light-emitting element LED may not emit the light. In the fourth period P4, the driving current ILED corresponding to the constant current generation voltage VCCG may flow through the light-emitting element LED for a time duration corresponding to the data voltage VDAT, and the light-emitting element LED may emit the light with a luminance corresponding to the constant current generation voltage VCCG for the time duration corresponding to the data voltage VDAT. Accordingly, the luminance of the light emitted from the light-emitting element LED may correspond to the emission time duration of the light-emitting element LED.

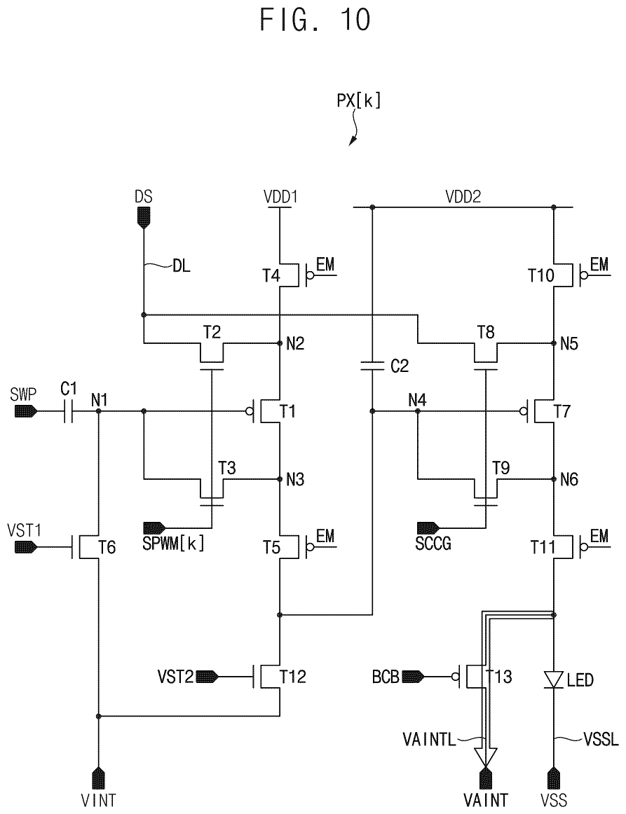

Referring to FIGS. 4 and 10, in the fifth period P5, the 13^{th} transistor T13 may be turned on in response to the bypass gate signal BCB having the turn-on voltage level. Accordingly, charges stored in the first electrode of the light-emitting element LED by a parasitic capacitor of the light-emitting element LED may be discharged to the second initialization voltage line VAINTL through the 13^{th} transistor T13, and the leakage current may be prevented from flowing through the light-emitting element LED.

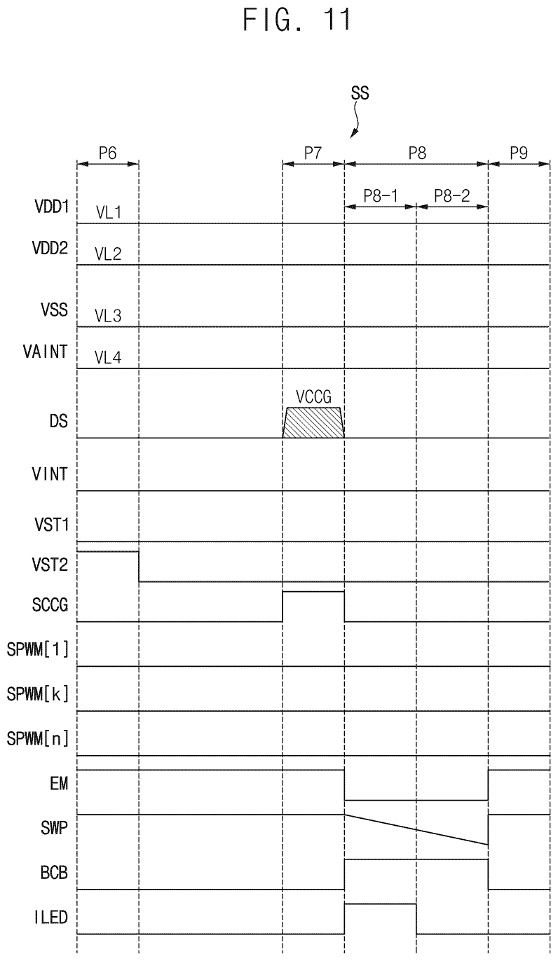

FIG. 11 is a view showing an embodiment of signals and voltages provided to pixels PX included in the display device 100 of FIG. 1 in the self scan period SS.

Referring to FIGS. 1, 3, and 11, the self scan period SS may include a second initialization period P6 (hereinafter also referred to as a “sixth period”) in which the gate electrode of the seventh transistor T7 is initialized, a third write period P7 (hereinafter also referred to as a “seventh period”) in which the constant current generation voltage VCCG for which the threshold voltage of the seventh transistor T7 is compensated is written to the gate electrode of the seventh transistor T7, a second emission period P8 (hereinafter also referred to as an “eighth period”) in which the light-emitting element LED emits a light, and a second bypass period P9 (hereinafter also referred to as a “ninth period”) in which charges of the light-emitting element LED are discharged. The eighth period P8 may include an eighth-first period P8-1 in which the driving current ILED having the constant level flows through the light-emitting element LED, and an eighth-second period P8-2 in which the driving current ILED does not flow through the light-emitting element LED. The periods P6, P7, and P9 except for the eighth period P8 in the self scan period SS may be non-emission periods.

Regarding signals and voltages that will be described with reference to FIG. 11, descriptions of components that are substantially identical or similar to the components of the signals and the voltages described with reference to FIG. 4 will be omitted.

The data signal DS may have the constant current generation voltage VCCG in the seventh period P7.

The first initialization gate signal VST1 have a turn-off voltage level in the sixth to ninth periods P6 to P9. The second initialization gate signal VST2 have a turn-on voltage level in the sixth period P6, and have a turn-off voltage level in the seventh to ninth periods P7 to P9.

Each of the scan signals SPWM[1], . . . , SPWM[k], . . . , and SPWM[n] may have a turn-off voltage level in the sixth to ninth periods P6 and P9.

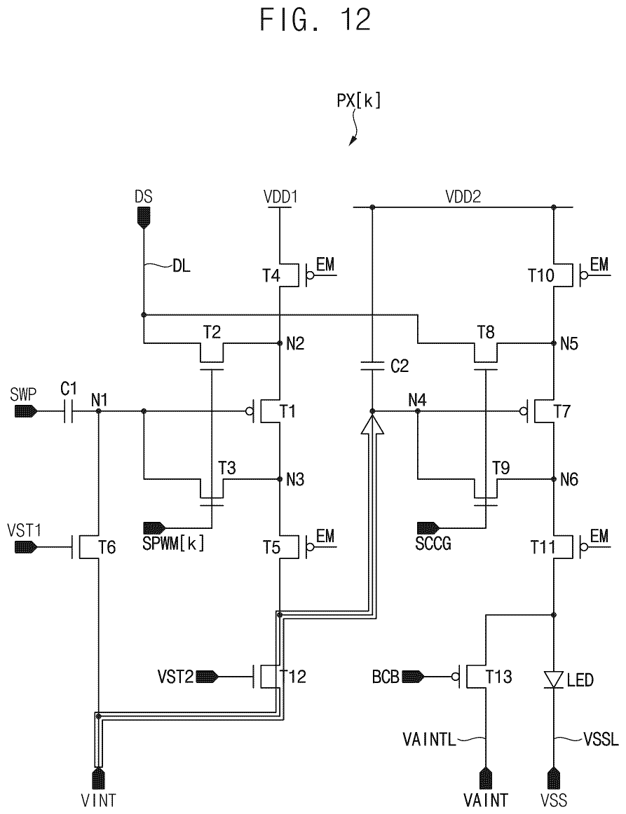

FIGS. 12 to 16 are views for describing an operation of the pixel PX[k] of FIG. 3 in the self scan period SS.

Referring to FIGS. 11 and 12, in the sixth period P6, the 12^{th} transistor T12 may be turned on in response to the second initialization gate signal VST2 having the turn-on voltage level. Accordingly, the first initialization voltage VINT may be applied to the fourth node N4 through the 12^{th} transistor T12, and the gate electrode of the seventh transistor T7 may be initialized.

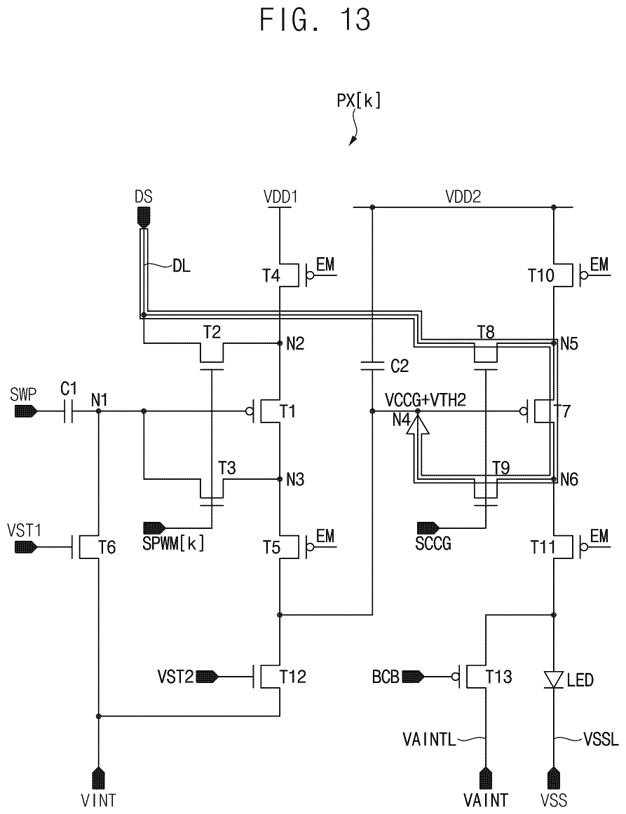

Referring to FIGS. 11 and 13, in the seventh period P7, the eighth transistor T8 and the ninth transistor T9 may be turned on in response to the constant current generation scan signal SCCG having the turn-on voltage level. Accordingly, the constant current generation voltage VCCG for which the threshold voltage VTH2 of the seventh transistor T7 is compensated may be applied to the fourth node N4 through the eighth transistor T8, the seventh transistor T7, and the ninth transistor T9.

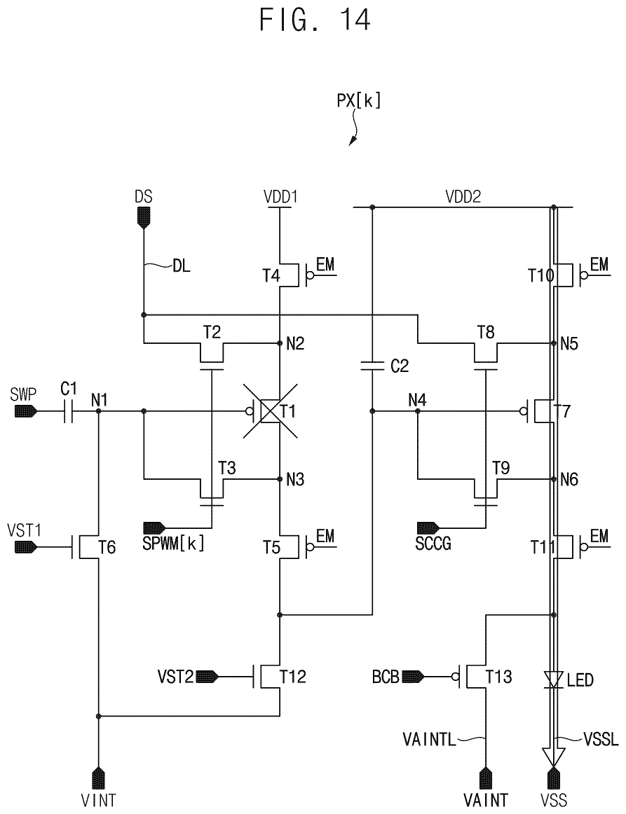

Referring to FIGS. 11 and 14, in the eighth-first period P8-1, the seventh transistor T7 may generate the driving current ILED having the constant level corresponding to a voltage difference between the first electrode and the gate electrode of the seventh transistor T7 (i.e., the voltage difference between the fifth node N5 and the fourth node N4), and the light-emitting element LED may emit the light with a luminance corresponding to the driving current ILED. In the eighth period P8, the sweep signal SWP may linearly decrease from the relatively high voltage level to the relatively low voltage level, and the emission control signal EM may have the turn-on voltage level. Accordingly, the voltage of the first node N1 may change in response to the change in the sweep signal SWP caused by a coupling effect of the first capacitor C1, and the first high power voltage VDD1 may be applied to the second node N2. Accordingly, in the eighth-first period P8-1, a voltage difference between the first electrode and the gate electrode of the first transistor T1 (i.e., the difference between the first high power voltage VDD1 and the voltage of the first node N1) may be less than the threshold voltage VTH1 of the first transistor T1, so that the first transistor T1 may be turned off.

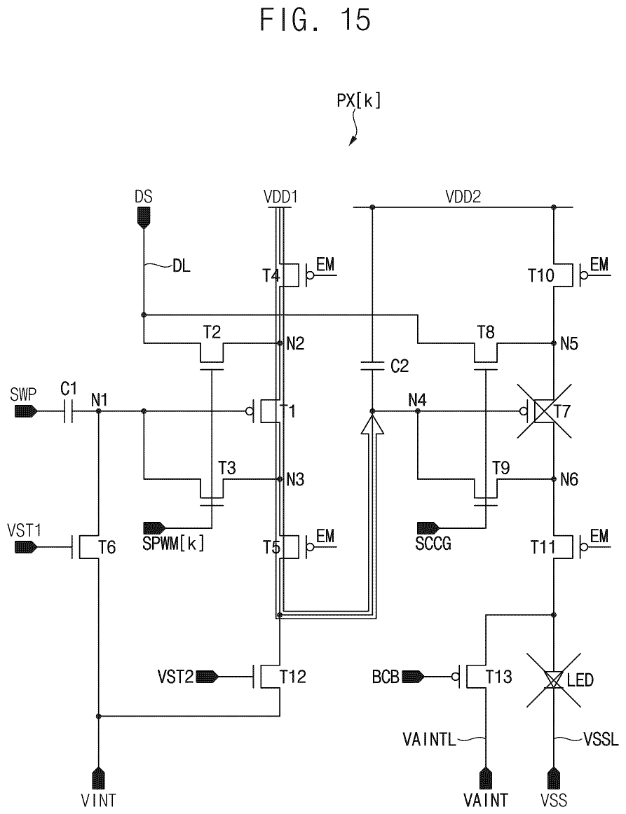

Referring to FIGS. 11 and 15, in the eighth-second period P8-2, since the sweep signal SWP linearly decreases by the coupling effect of the first capacitor C1, the voltage of the first node N1 may be continuously decreased. Accordingly, the voltage difference between the first electrode and the gate electrode of the first transistor T1 (i.e., the difference between the first high power voltage VDD1 and the voltage of the first node N1) may be greater than the threshold voltage VTH1 of the first transistor T1, and the first transistor T1 may be turned on. The first high power voltage VDD1 may be applied to the fourth node N4 through the fourth transistor T4, the first transistor T1, and the fifth transistor T5, and the seventh transistor T7 may be turned off. Accordingly, the seventh transistor T7 may stop generating the driving current ILED, and the light-emitting element LED may not emit the light. In the eighth period P8, the driving current ILED corresponding to the constant current generation voltage VCCG may flow through the light-emitting element LED for a time duration corresponding to the data voltage VDAT written in the second period P2, and the light-emitting element LED may emit the light with a luminance corresponding to the constant current generation voltage VCCG for the time duration corresponding to the data voltage VDAT written in the second period P2. Accordingly, the luminance of the light emitted from the light-emitting element LED may correspond to the emission time duration of the light-emitting element LED.

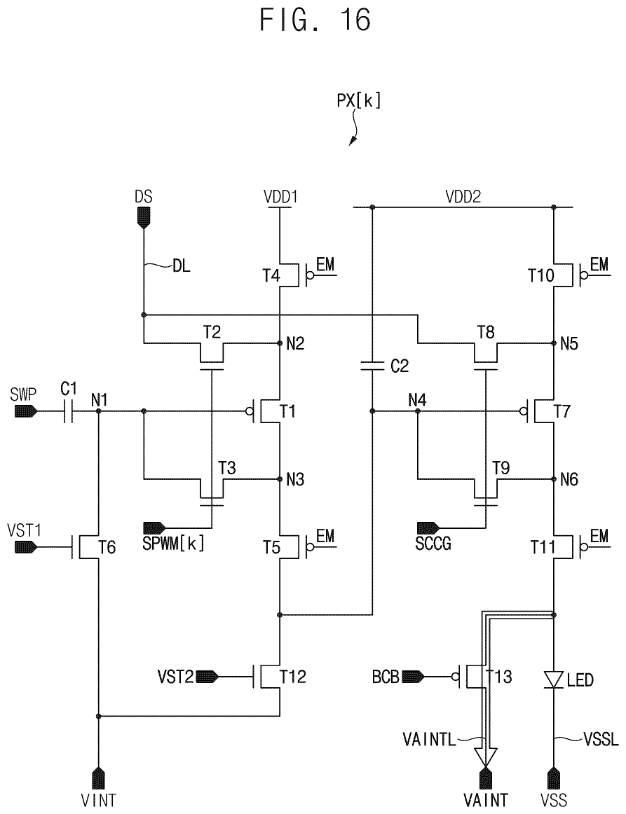

Referring to FIGS. 11 and 16, in the ninth period P9, the 13^{th} transistor may be turned on in response to the bypass gate signal BCB having the turn-on voltage level. Accordingly, charges stored in the first electrode of the light-emitting element LED by the parasitic capacitor of the light-emitting element LED may be discharged to the second initialization voltage line VAINTL through the 13^{th} transistor T13, and the leakage current may be prevented from flowing through the light-emitting element LED.

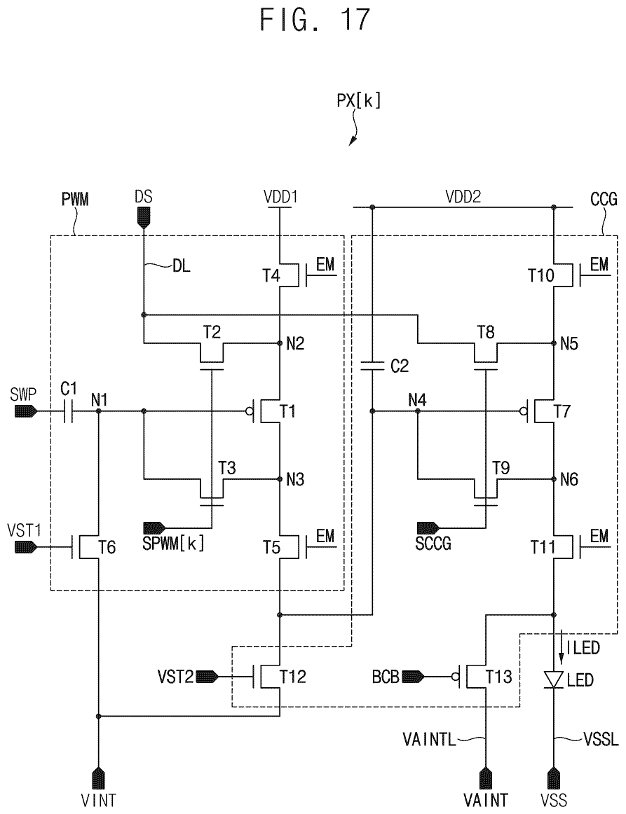

FIG. 17 is a circuit diagram showing another embodiment of a pixel PX[k] included in the display device 100 of FIG. 1.

Referring to FIGS. 1 and 17, the pixel PX[k] may include a light-emitting element LED, a pulse width modulator PWM, and a constant current generator CCG. Regarding the pixel PX[k] that will be described with reference to FIG. 17, descriptions of components that are substantially identical or similar to the components of the pixel PX[k] described with reference to FIG. 3 will be omitted.

In an embodiment, each of the first transistor T1, the seventh transistor T7, and the 13^{th} transistor T13 may be a P-type transistor, and each of the second transistor T2, the third transistor T3, the fourth transistor T4, the fifth transistor T5, the sixth transistor T6, the eighth transistor T8, the ninth transistor T9, the 10^{th} transistor T10, the 11^{th} transistor T11, and the 12^{th} transistor T12 may be an N-type transistor. In an embodiment, each of the first transistor T1, the seventh transistor T7, and the 13^{th} transistor T13 may be a polycrystalline silicon transistor, and each of the second transistor T2, the third transistor T3, the fourth transistor T4, the fifth transistor T5, the sixth transistor T6, the eighth transistor T8, the ninth transistor T9, the 10^{th} transistor T10, the 11^{th} transistor T11, and the 12^{th} transistor T12 may be an oxide semiconductor transistor.

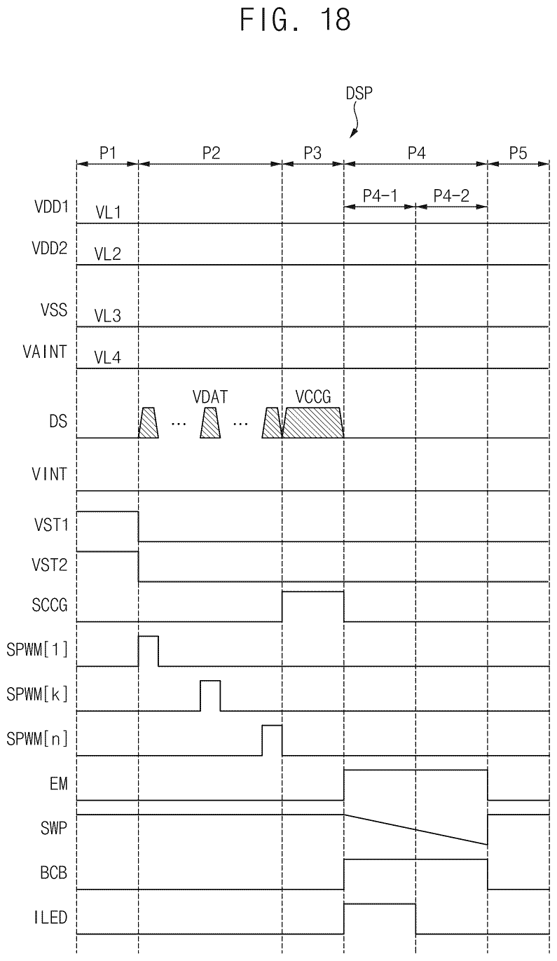

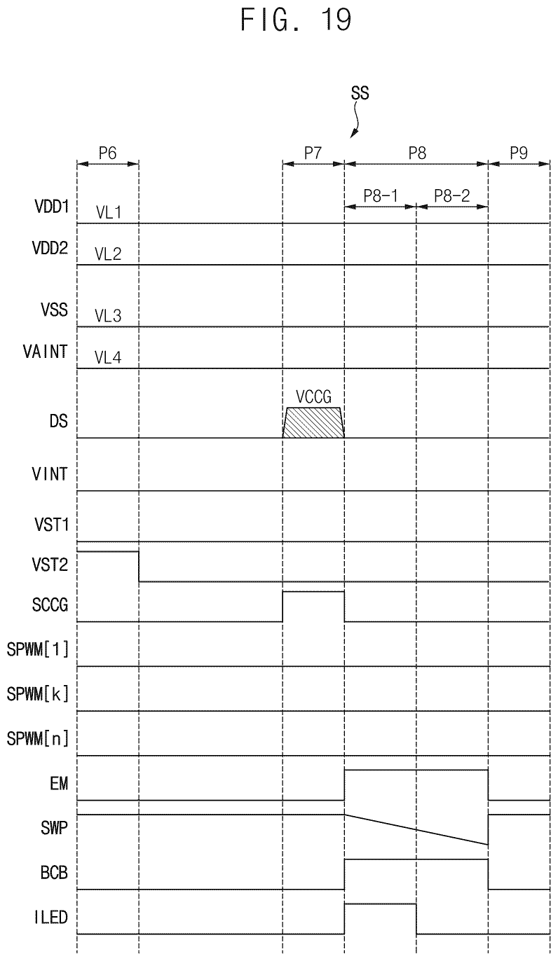

FIG. 18 is a view showing another embodiment of signals and voltages provided to pixels PX included in the display device 100 of FIG. 1 in the display scan period DSP. FIG. 19 is a view showing another embodiment of signals and voltages provided to pixels PX included in the display device 100 of FIG. 1 in the self scan period SS.

Regarding signals and voltages that will be described with reference to FIGS. 18 and 19, descriptions of components that are substantially identical or similar to the components of the signals and the voltages described with reference to FIGS. 4 and 11 will be omitted.

Referring to FIGS. 18 and 19, the emission control signal EM may have a turn-on voltage level (e.g., logic relatively high level) in the fourth and eighth periods P4 and P8, and have a turn-off voltage level (e.g., logic relatively low level) in the first to third, fifth to seventh, and ninth periods P1 to P3, P5 to P7, and P9.

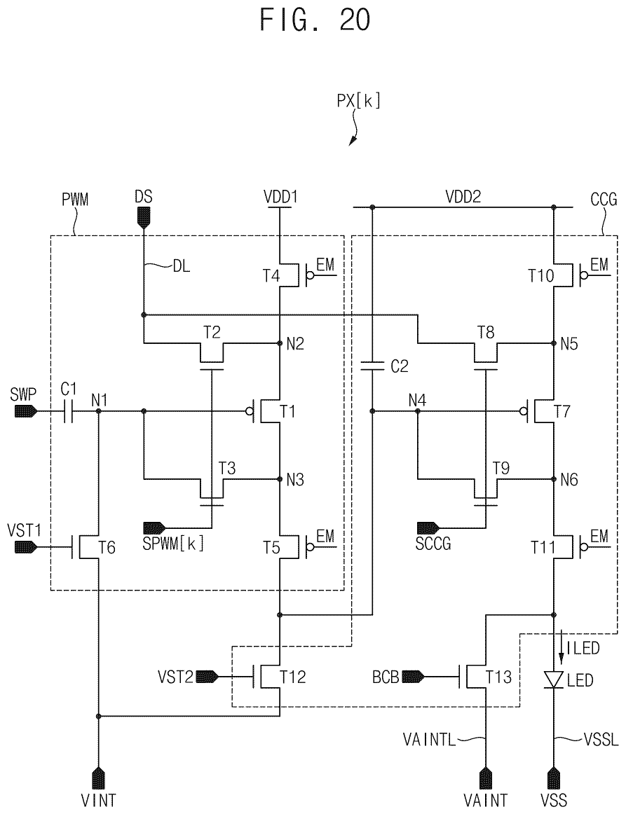

FIG. 20 is a circuit diagram showing another embodiment of a pixel PX[k] included in the display device 100 of FIG. 1.

Referring to FIGS. 1 and 20, the pixel PX[k] may include a light-emitting element LED, a pulse width modulator PWM, and a constant current generator CCG. Regarding the pixel PX[k] that will be described with reference to FIG. 20, descriptions of components that are substantially identical or similar to the components of the pixel PX[k] described with reference to FIG. 3 will be omitted.

In an embodiment, each of the first transistor T1, the fourth transistor T4, the fifth transistor T5, the seventh transistor T7, the 10^{th} transistor T10, and the 11^{th} transistor T11 may be a P-type transistor, and each of the second transistor T2, the third transistor T3, the sixth transistor T6, the eighth transistor T8, the ninth transistor T9, the 12^{th} transistor T12, and the 13^{th} transistor T13 may be an N-type transistor. In an embodiment, each of the first transistor T1, the fourth transistor T4, the fifth transistor T5, the seventh transistor T7, the 10^{th} transistor T10, and the 11^{th} transistor T11 may be a polycrystalline silicon transistor, and each of the second transistor T2, the third transistor T3, the sixth transistor T6, the eighth transistor T8, the ninth transistor T9, the 12^{th} transistor T12, and the 13^{th} transistor T13 may be an oxide semiconductor transistor.

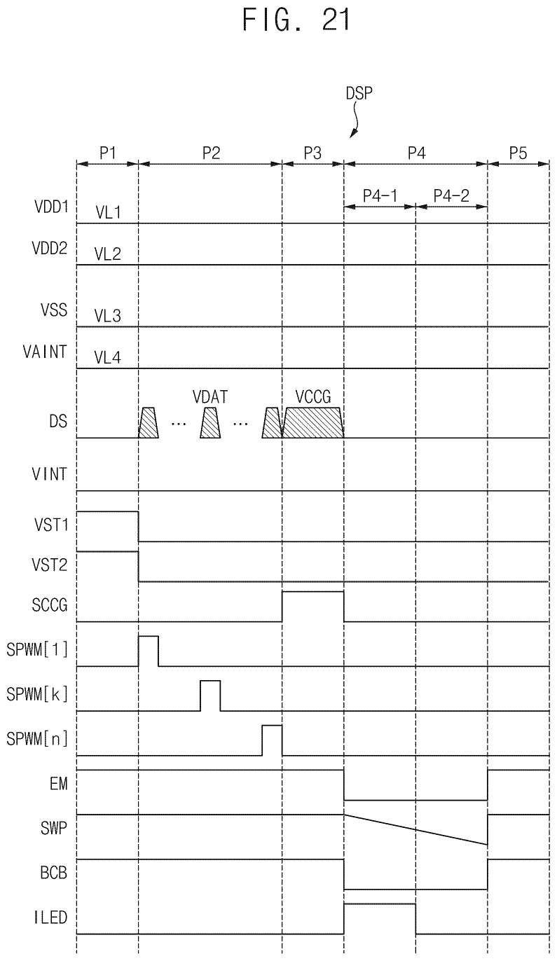

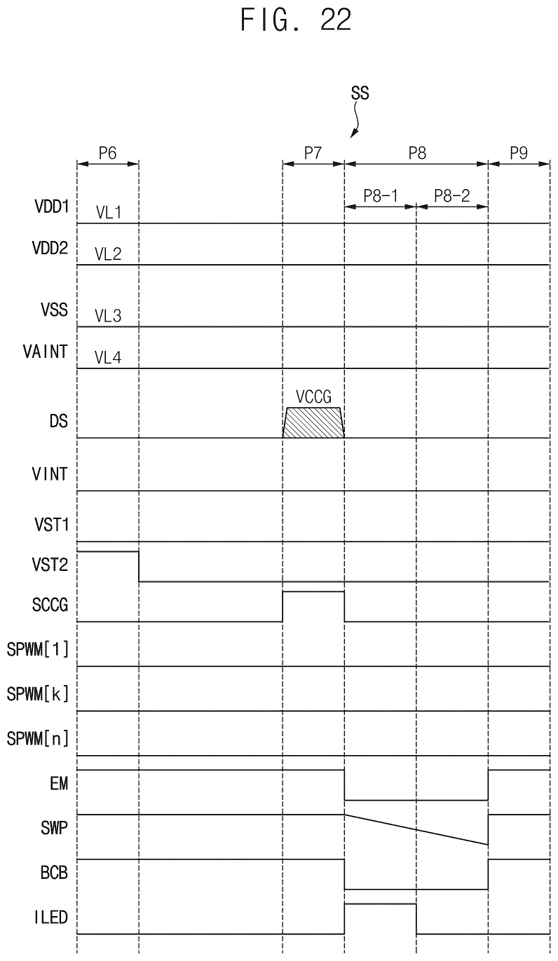

FIG. 21 is a view showing another embodiment of signals and voltages provided to pixels PX included in the display device 100 of FIG. 1 in the display scan period DSP. FIG. 22 is a view showing another embodiment of signals and voltages provided to pixels PX included in the display device 100 of FIG. 1 in the self scan period SS.

Regarding signals and voltages that will be described with reference to FIGS. 21 and 22, descriptions of components that are substantially identical or similar to the components of the signals and the voltages described with reference to FIGS. 4 and 11 will be omitted.

Referring to FIGS. 21 and 22, the bypass gate signal BCB may have a turn-on voltage level (e.g., logic relatively high level) in the first to third, fifth to seventh, and ninth periods P1 to P3 and P5 to P7, and P9, and have a turn-off voltage level (e.g., logic relatively low level) in the fourth and eighth periods P4 and P8.

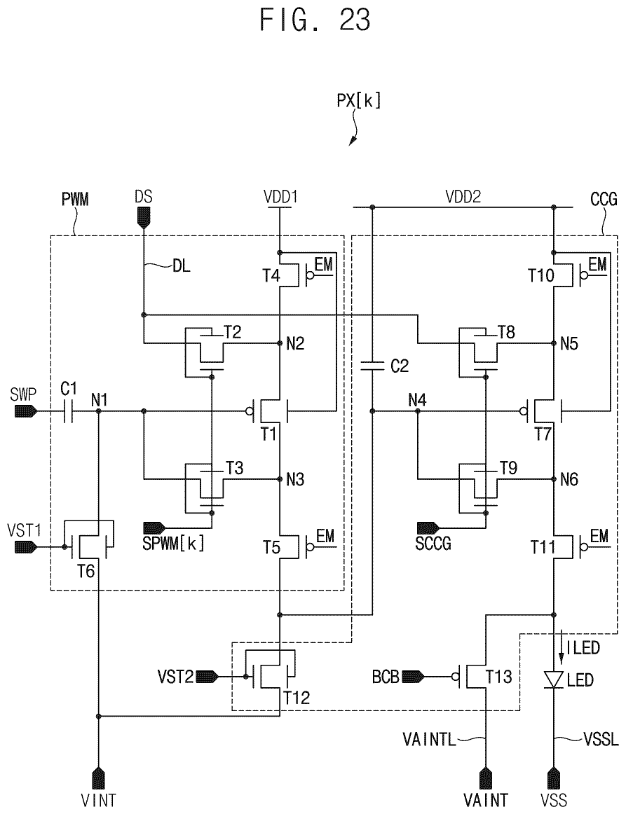

FIG. 23 is a circuit diagram showing another embodiment of a pixel PX[k] included in the display device 100 of FIG. 1.

Referring to FIGS. 1 and 23, the pixel PX[k] may include a light-emitting element LED, a pulse width modulator PWM, and a constant current generator CCG. Regarding the pixel PX[k] that will be described with reference to FIG. 23, descriptions of components that are substantially identical or similar to the components of the pixel PX[k] described with reference to FIG. 3 will be omitted.

The first transistor T1 may include a first gate electrode connected to a first node N1, a second gate electrode which receives the first high power voltage VDD1, a first electrode connected to a second node N2, and a second electrode connected to a third node N3. Accordingly, the first transistor T1 may have a dual gate structure including the first and second gate electrodes.

The second transistor T2 may include a first gate electrode which receives a scan signal SPWM[k], a second gate electrode which receives the scan signal SPWM[k], a first electrode connected to a data line DL which transmits the data signal DS, and a second electrode connected to the second node N2. Accordingly, the second transistor T2 may have a dual gate structure including the first and second gate electrodes.

The third transistor T3 may include a first gate electrode which receives the scan signal SPWM[k], a second gate electrode which receives the scan signal SPWM[k], a first electrode connected to the third node N3, and a second electrode connected to the first node N1. Accordingly, the third transistor T3 may have a dual gate structure including the first and second gate electrodes.

The sixth transistor T6 may include a first gate electrode which receives the first initialization gate signal VST1, a second gate electrode which receives the first initialization gate signal VST1, a first electrode which receives the first initialization voltage VINT, and a second electrode connected to the first node N1. Accordingly, the sixth transistor T6 may have a dual gate structure including the first and second gate electrodes.

The seventh transistor T7 may include a first gate electrode connected to the fourth node N4, a second gate electrode which receives the second high power voltage VDD2, a first electrode connected to a fifth node N5, and a second electrode connected to a sixth node N6. Accordingly, the seventh transistor T7 may have a dual gate structure including the first and second gate electrodes.

The eighth transistor T8 may include a first gate electrode which receives the constant current generation scan signal SCCG, a second gate electrode which receives the constant current generation scan signal SCCG, a first electrode connected to the data line DL, and a second electrode connected to the fifth node N5. Accordingly, the eighth transistor T8 may have a dual gate structure including the first and second gate electrodes.

The ninth transistor T9 may include a first gate electrode which receives the constant current generation scan signal SCCG, a second gate electrode which receives the constant current generation scan signal SCCG, a first electrode connected to the sixth node N6, and a second electrode connected to the fourth node N4. Accordingly, the ninth transistor T9 may have a dual gate structure including the first and second gate electrodes.

The 12^{th} transistor T12 may include a first gate electrode which receives the second initialization gate signal VST2, a second gate electrode which receives the second initialization gate signal VST2, a first electrode which receives the first initialization voltage VINT, and a second electrode connected to the fourth node N4. Accordingly, the 12^{th} transistor T12 may have a dual gate structure including the first and second gate electrodes.

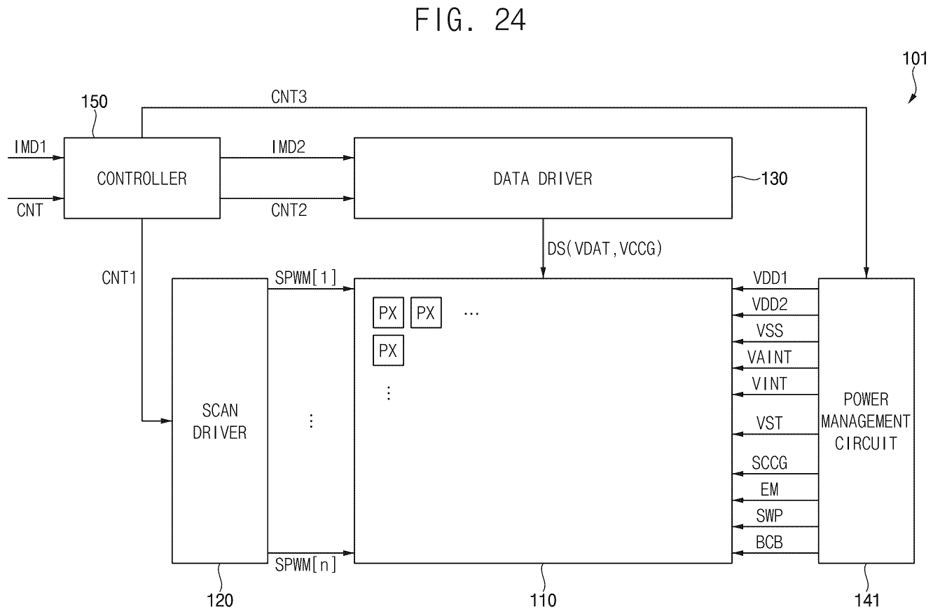

FIG. 24 is a block diagram showing an embodiment of a display device 101.

Referring to FIG. 24, a display device 101 may include a display panel 110, a scan driver 120, a data driver 130, a power management circuit 141, and a controller 150. Regarding the display device 101 that will be described with reference to FIG. 24, descriptions of components that are substantially identical or similar to the components of the display device 100 described with reference to FIG. 1 will be omitted.

The power management circuit 141 may commonly provide a first high power voltage VDD1, a second high power voltage VDD2, a low power voltage VSS, a second initialization voltage VAINT, a first initialization voltage VINT, an initialization gate signal VST, a constant current generation scan signal SCCG, an emission control signal EM, a sweep signal SWP, and a bypass gate signal BCB to the pixels PX. The power management circuit 141 may generate the first high power voltage VDD1, the second high power voltage VDD2, the low power voltage VSS, the second initialization voltage VAINT, the first initialization voltage VINT, the initialization gate signal VST, the constant current generation scan signal SCCG, the emission control signal EM, the sweep signal SWP, and the bypass gate signal BCB based on a third control signal CNT3.

The display device 101 may display an image by a fixed frequency driving scheme which is incapable of changing a driving frequency. Each frame of the display device 101 may include the display scan period DSP of FIG. 2 only.

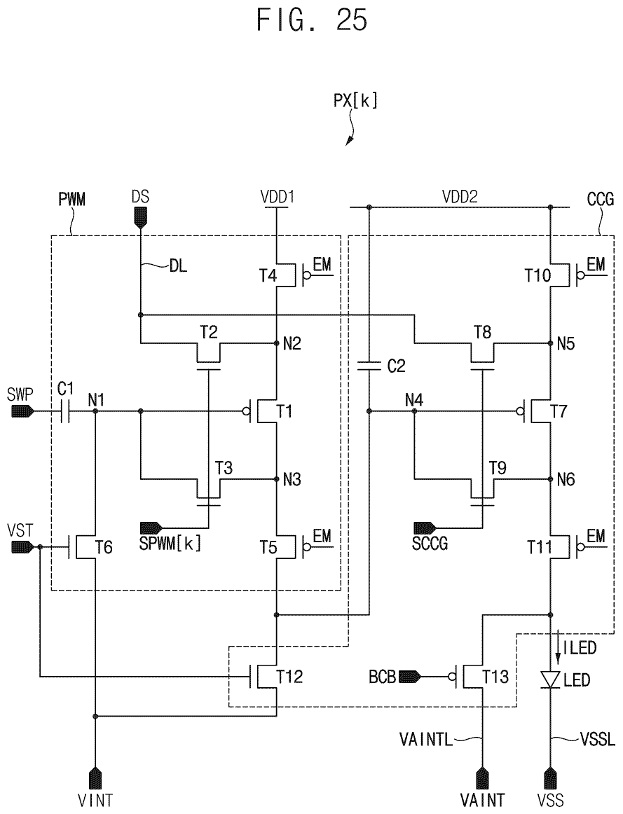

FIG. 25 is a circuit diagram showing an embodiment of a pixel PX[k] included in the display device 101 of FIG. 24.

Referring to FIGS. 24 and 25, the pixel PX[k] may include a light-emitting element LED, a pulse width modulator PWM, and a constant current generator CCG. Regarding the pixel PX[k] that will be described with reference to FIG. 25, descriptions of components that are substantially identical or similar to the components of the pixel PX[k] described with reference to FIG. 3 will be omitted.

The sixth transistor T6 may include a gate electrode which receives the initialization gate signal VST, a first electrode which receives the first initialization voltage VINT, and a second electrode connected to the first node N1. The sixth transistor T6 may transmit the first initialization voltage VINT to the first node N1 in response to the initialization gate signal VST having a turn-on voltage level.

The 12^{th} transistor T12 may include a gate electrode which receives the initialization gate signal VST, a first electrode which receives the first initialization voltage VINT, and a second electrode connected to the fourth node N4. The 12^{th} transistor T12 may transmit the first initialization voltage VINT to the fourth node N4 in response to the initialization gate signal VST having the turn-on voltage level.

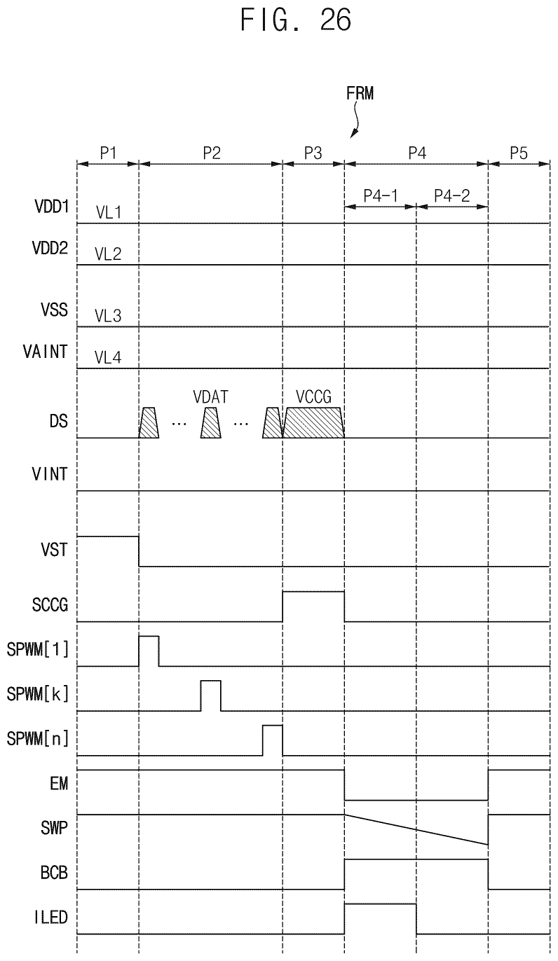

FIG. 26 is a view showing another embodiment of signals and voltages provided to pixels PX included in the display device 101 of FIG. 24 in a frame FRM.

Regarding signals and voltages that will be described with reference to FIG. 26, descriptions of components that are substantially identical or similar to the components of the signals and the voltages described with reference to FIG. 4 will be omitted.

Referring to FIG. 26, the initialization gate signal VST may have a turn-on voltage level (e.g., logic relatively high level) in the first period P1, and have a turn-off voltage level (e.g., logic relatively low level) in the second to fifth periods P2 to P5.

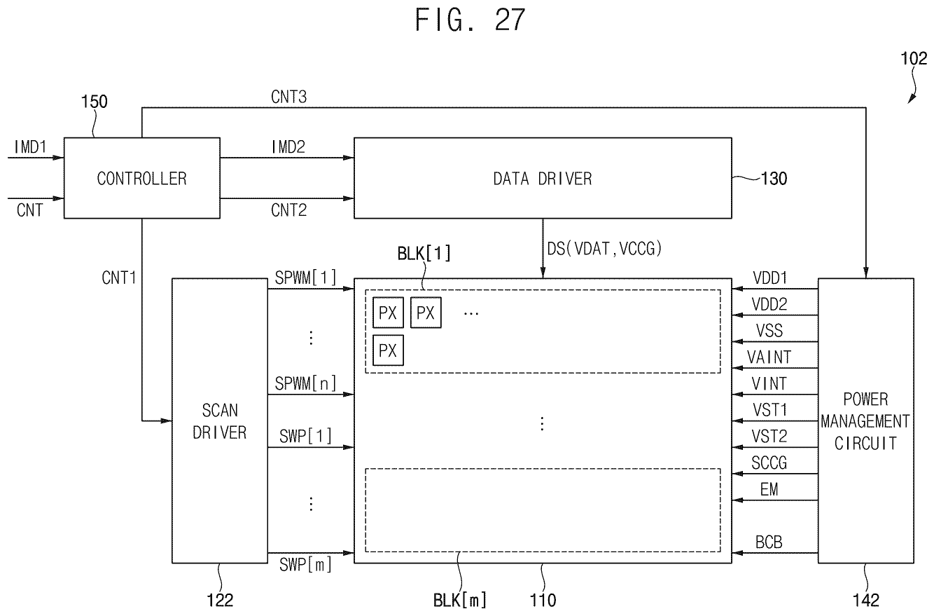

FIG. 27 is a block diagram showing an embodiment of a display device 102.

Referring to FIG. 27, a display device 102 may include a display panel 110, a scan driver 122, a data driver 130, a power management circuit 142, and a controller 150. Regarding the display device 102 that will be described with reference to FIG. 27, descriptions of components that are substantially identical or similar to the components of the display device 100 described with reference to FIG. 1 will be omitted.

The scan driver 122 may sequentially provide first to n^{th} scan signals SPWM[1] to SPWM[n] and first to m^{th} sweep signals SWP[1] to SWP[m] (where m is a natural number that is greater than 1) to the pixels PX. The scan driver 122 may sequentially generate the first to m^{th} sweep signals SWP[1] to SWP[m] corresponding to first to m^{th} blocks BLK[1] to BLK[m], respectively, based on a first control signal CNT1. Each of the first to m^{th} blocks BLK[1] to BLK[m] may include a plurality of pixel rows.

The power management circuit 142 may commonly provide a first high power voltage VDD1, a second high power voltage VDD2, a low power voltage VSS, a second initialization voltage VAINT, a first initialization voltage VINT, a first initialization gate signal VST1, a second initialization gate signal VST2, a constant current generation scan signal SCCG, an emission control signal EM, and a bypass gate signal BCB to the pixels PX.

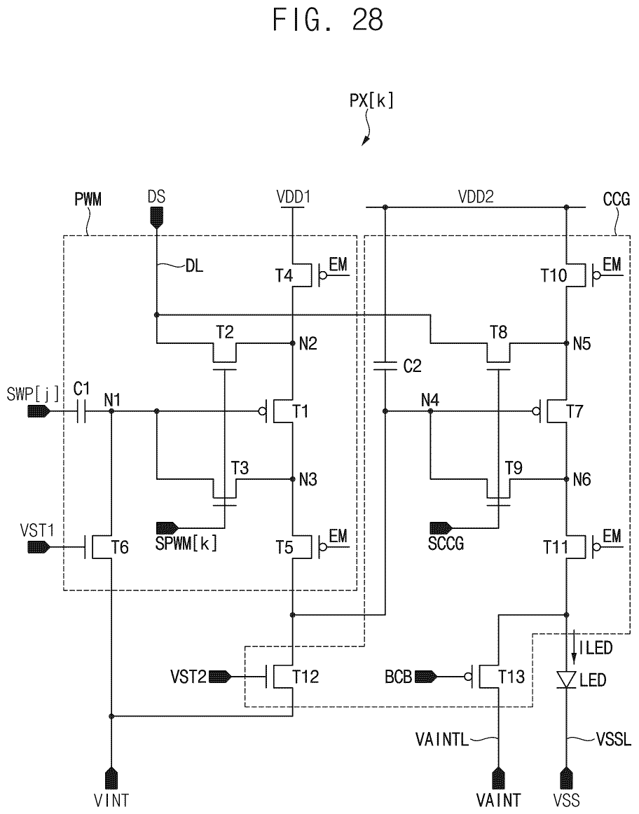

FIG. 28 is a circuit diagram showing an embodiment of a pixel PX[k] included in the display device 102 of FIG. 27.

Referring to FIGS. 27 and 28, the pixel PX[k] may include a light-emitting element LED, a pulse width modulator PWM, and a constant current generator CCG. Regarding the pixel PX[k] that will be described with reference to FIG. 28, descriptions of components that are substantially identical or similar to the components of the pixel PX[k] described with reference to FIG. 3 will be omitted.

The first capacitor C1 may include a first electrode which receives a sweep signal SWP[j] corresponding to a j^{th} block in which the pixel PX[k] is included and a second electrode connected to the first node N1.

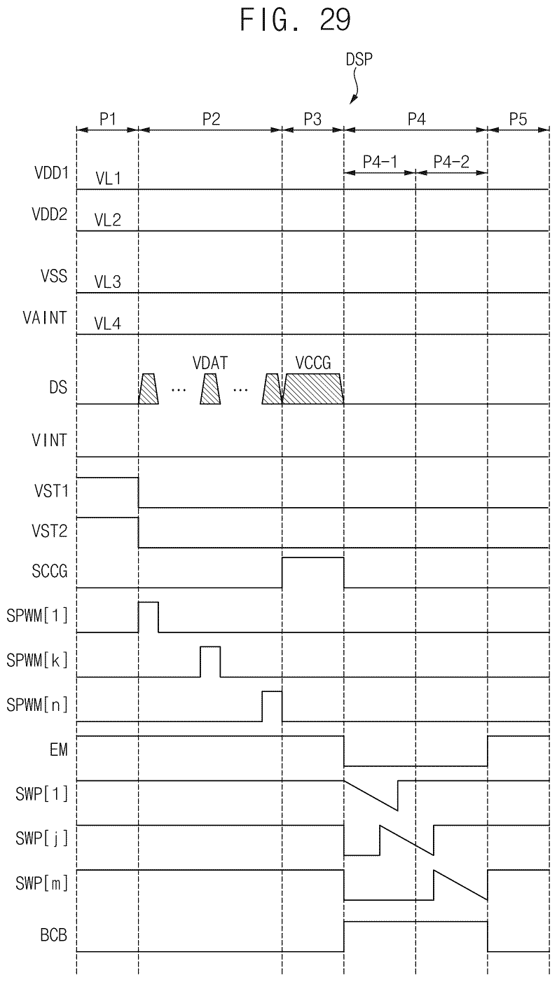

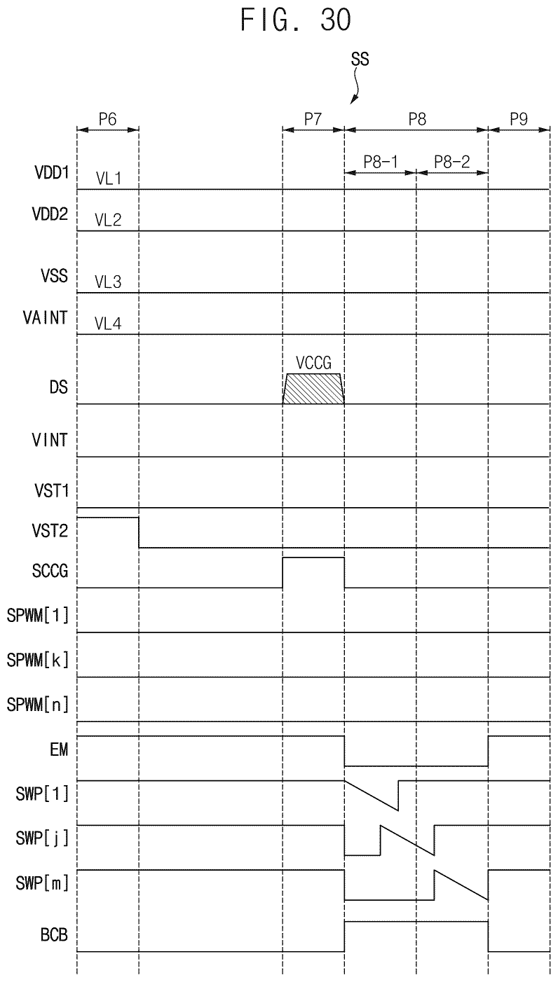

FIG. 29 is a view showing an embodiment of signals and voltages provided to pixels PX included in the display device 102 of FIG. 27 in the display scan period DSP. FIG. 30 is a view showing an embodiment of signals and voltages provided to pixels PX included in the display device 102 of FIG. 27 in the self scan period SS.

Regarding signals and voltages that will be described with reference to FIGS. 29 and 30, descriptions of components that are substantially identical or similar to the components of the signals and the voltages described with reference to FIGS. 4 and 11 will be omitted.

Referring to FIGS. 29 and 30, the first high power voltage VDD1, the second high power voltage VDD2, the low power voltage VSS, the second initialization voltage VAINT, the first initialization voltage VINT, the first initialization gate signal VST1, the second initialization gate signal VST2, the constant current generation scan signal SCCG, the emission control signal EM, and the bypass gate signal BCB may be commonly provided to the pixels PX. The scan signals SPWM[1], . . . , SPWM[k], . . . , and SPWM[n] may be sequentially provided to the pixels PX on a pixel row basis. The sweep signals SWP[1], . . . , SWP[j], . . . , and SWP[m] may be sequentially provided to the pixels PX on a block basis.

Each of the sweep signals SWP[1], . . . , SWP[j], . . . , and SWP[m] may have a relatively high voltage level in the first to third, fifth to seventh, and ninth periods P1 to P3, P5 to P7, and P9, and have the relatively high voltage level after linearly decreasing from the relatively high voltage level to a relatively low voltage level in the fourth and eighth periods P4 and P8. Each of the sweep signals . . . , SWP[j], . . . , and SWP[m] except for the first sweep signal SWP[1] may have the relatively low voltage level before linearly decreasing from the relatively high voltage level to the relatively low voltage level. In the fourth and eighth periods P4 and P8, durations in which the sweep signals SWP[1], . . . . SWP[j], . . . , and SWP[m] linearly decrease from the relatively high voltage level to the relatively low voltage level may be sequentially shifted by a predetermined time duration.

In the display device 102 described with reference to FIGS. 27 to 30, the sweep signals SWP[1], . . . , SWP[j], . . . , and SWP[m] respectively having the durations in which the sweep signals SWP[1], . . . , SWP[j], . . . , and SWP[m] linearly decreasing from the high voltage level to the low voltage level are sequentially shifted may be provided to the first to m^{th} blocks BLK[1] to BLK[m], respectively, so that the pixels PX may sequentially emit light on a block basis in the fourth and eighth periods P4 and P8.

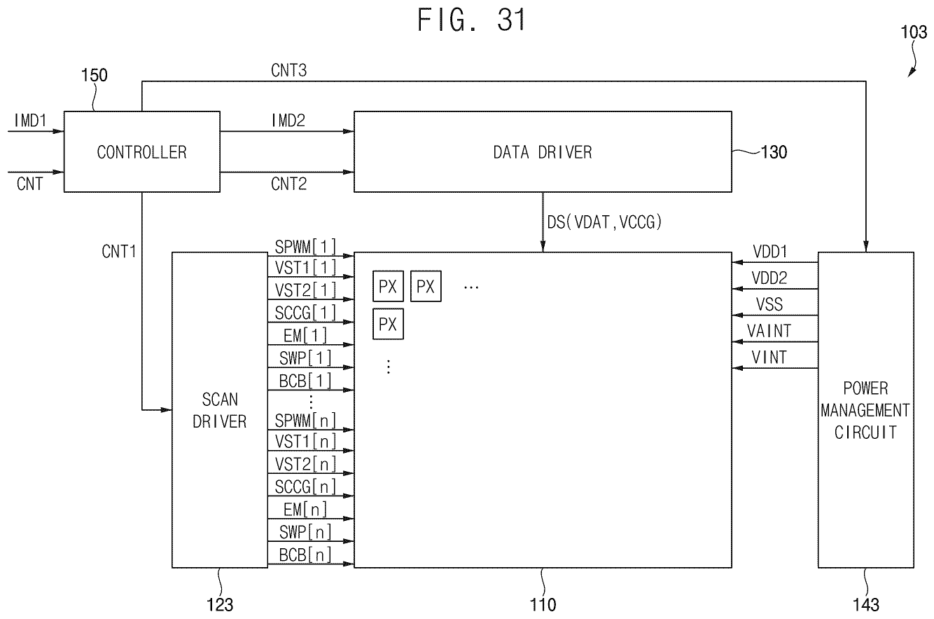

FIG. 31 is a block diagram showing an embodiment of a display device 103.

Referring to FIG. 31, a display device 103 may include a display panel 110, a scan driver 123, a data driver 130, a power management circuit 143, and a controller 150. Regarding the display device 103 that will be described with reference to FIG. 31, descriptions of components that are substantially identical or similar to the components of the display device 100 described with reference to FIG. 1 will be omitted.

The scan driver 123 may sequentially provide first to n^{th} scan signals SPWM[1] to SPWM[n], first to n^{th} first initialization gate signals VST1[1] to VST1[n], first to n^{th} second initialization gate signals VST2[1] to VST2[n], first to n^{th} constant current generation scan signals SCCG[1] to SCCG[n], first to n^{th} emission control signals EM[1] to EM[n], first to n^{th} sweep signals SWP[1] to SWP[n], and first to n^{th} bypass gate signals BCB[1] to BCB[n] to the pixels PX. The scan driver 123 may sequentially generate the first to n^{th} scan signals SPWM[1] to SPWM[n], the first to n^{th} first initialization gate signals VST1[1] to VST1[n], the first to n^{th} second initialization gate signals VST2[1] to VST2[n], the first to n^{th} constant current generation scan signals SCCG[1] to SCCG[n], the first to n^{th} emission control signals EM[1] to EM[n], the first to n^{th} sweep signals SWP[1] to SWP[n], and the first to n^{th} bypass gate signals BCB[1] to BCB[n] based on a first control signal CNT1.

The power management circuit 143 may commonly provide a first high power voltage VDD1, a second high power voltage VDD2, a low power voltage VSS, a second initialization voltage VAINT, and a first initialization voltage VINT to the pixels PX.

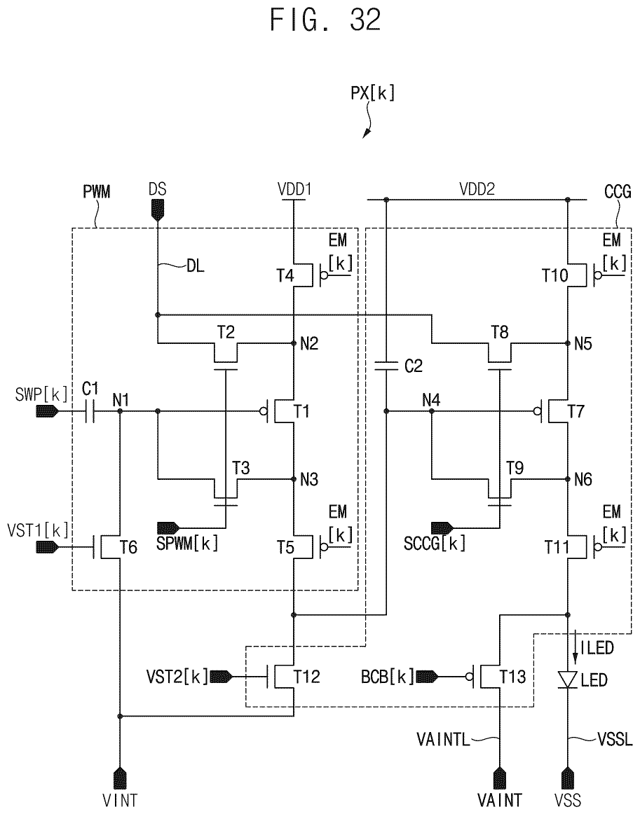

FIG. 32 is a circuit diagram showing an embodiment of a pixel PX[k] included in the display device 103 of FIG. 31.

Referring to FIGS. 31 and 32, the pixel PX[k] may include a light-emitting element LED, a pulse width modulator PWM, and a constant current generator CCG. Regarding the pixel PX[k] that will be described with reference to FIG. 32, descriptions of components that are substantially identical or similar to the components of the pixel PX[k] described with reference to FIG. 3 will be omitted.

The fourth transistor T4 may include a gate electrode which receives an emission control signal EM[k] corresponding to the pixel PX[k], a first electrode which receives the first high power voltage VDD1, and a second electrode connected to the second node N2.

The fifth transistor T5 may include a gate electrode which receives the emission control signal EM[k], a first electrode connected to the third node N3, and a second electrode connected to a fourth node N4.

The sixth transistor T6 may include a gate electrode which receives a first initialization gate signal VST1[k] corresponding to the pixel PX[k], a first electrode which receives the first initialization voltage VINT, and a second electrode connected to the first node N1.

The eighth transistor T8 may include a gate electrode which receives a constant current generation scan signal SCCG[k] corresponding to the pixel PX[k], a first electrode connected to the data line DL, and a second electrode connected to the fifth node N5.

The ninth transistor T9 may include a gate electrode which receives the constant current generation scan signal SCCG[k], a first electrode connected to the sixth node N6, and a second electrode connected to the fourth node N4.

The 10^{th} transistor T10 may include a gate electrode which receives the emission control signal EM[k], a first electrode which receives the second high power voltage VDD2, and a second electrode connected to the fifth node N5.

The 11^{th} transistor T11 may include a gate electrode which receives the emission control signal EM[k], a first electrode connected to the sixth node N6, and a second electrode connected to the first electrode of the light-emitting element LED.

The 12^{th} transistor T12 may include a gate electrode which receives a second initialization gate signal VST2[k] corresponding to the pixel PX[k], a first electrode which receives the first initialization voltage VINT, and a second electrode connected to the fourth node N4.

The 13^{th} transistor T13 may include a gate electrode which receives a bypass gate signal BCB[k] corresponding to the pixel PX[k], a first electrode connected to a second initialization voltage line VAINTL which transmits the second initialization voltage VAINT, and a second electrode connected to the first electrode of the light-emitting element LED.

The first capacitor C1 may include a first electrode which receives a sweep signal SWP[k] corresponding to the pixel PX[k], and a second electrode connected to the first node N1.

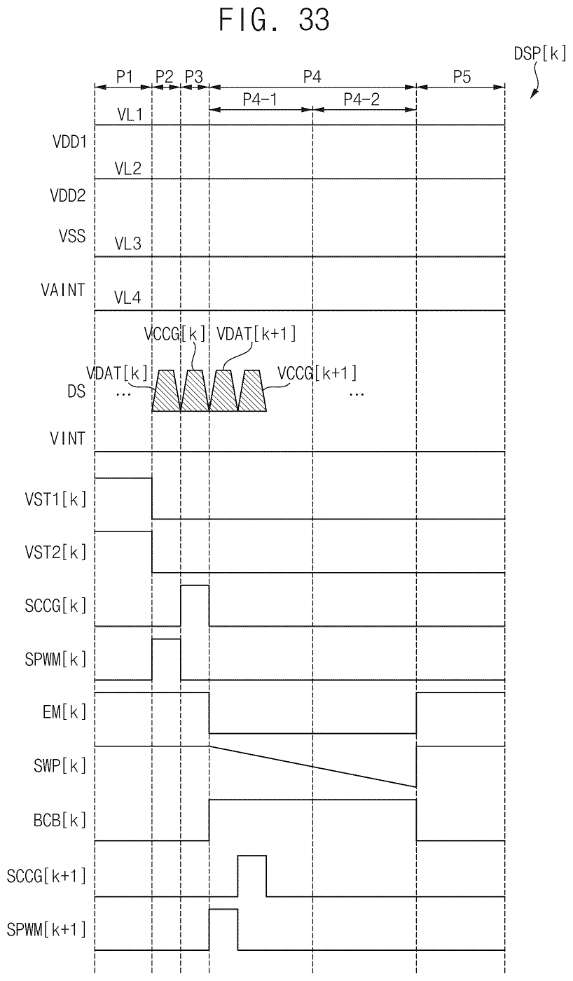

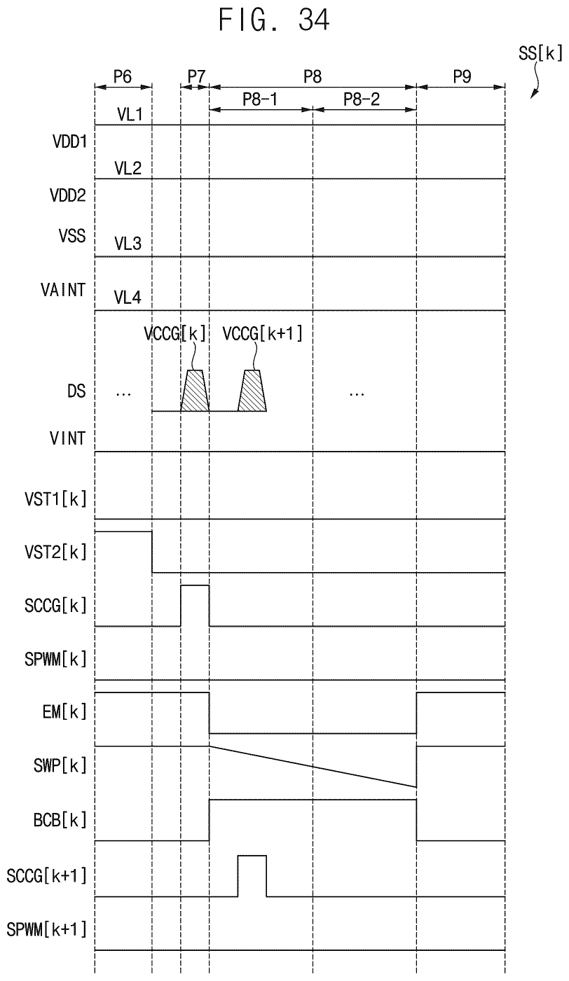

FIG. 33 is a view showing an embodiment of signals and voltages provided to the pixel PX[k] of FIG. 32 in the display scan period. FIG. 34 is a view showing an embodiment of signals and voltages provided to the pixel PX[k] of FIG. 32 in the self scan period.

Regarding signals and voltages that will be described with reference to FIGS. 31, 33, and 34, descriptions of components that are substantially identical or similar to the components of the signals and the voltages described with reference to FIGS. 4 and 11 will be omitted.

Referring to FIGS. 31, 33, and 34, the display scan period DSP[k] for a kth pixel row may include a first period P1, a second period P2, a third period P3, a fourth period P4, and a fifth period P5. The self scan period SS[k] for the kth pixel row may include a sixth period P6, a seventh period P7, an eighth period P8, and a ninth period P9. The display scan period and the self scan period for a pixel row may be shifted for a time duration corresponding to the first period P1 in a pixel row basis.

The first high power voltage VDD1, the second high power voltage VDD2, the low power voltage VSS, the second initialization voltage VAINT, and the first initialization voltage VINT may be commonly provided to the pixels PX. The first initialization gate signals VST1[1], . . . , VST1[k], . . . , and VST1[n], the second initialization gate signals VST2[1], . . . , VST2[k], . . . , and VST2[n], the constant current generation scan signals SCCG[1], . . . , SCCG[k], . . . , and SCCG[n], the scan signals SPWM[1], . . . , SPWM[k], . . . , and SPWM[n], the emission control signals EM[1], . . . , EM[k], . . . , and EM[n], the sweep signals SWP[1], . . . , SWP[k], . . . , and SWP[n], and the bypass gate signals BCB[1], . . . , BCB[k], . . . , and BCB[n] may be sequentially provided to the pixels PX on a pixel row basis.

The data signal DS may have the data voltage VDAT[k] in the second period P2, and have the constant current generation voltage VCCG[k] in the third period P3. A data voltage VDAT[k+1] and a constant current generation voltage VCCG[k+1] for a k+1^{th} pixel row may be shifted for a time duration corresponding to the first period P1 from the data voltage VDAT[k] and the constant current generation voltage VCCG[k] for the kth pixel row.

The first initialization gate signal VST1[k] may have a turn-on voltage level in the first period P1, and have a turn-off voltage level in the second to ninth periods P2 to P9.

The second initialization gate signal VST2[k] may have a turn-on voltage level in the first and sixth periods P1 and P6, and have a turn-off voltage level in the second to fifth and seventh to ninth periods P2 to P5 and P7 to P9.

The constant current generation scan signal SCCG[k] may have a turn-on voltage level in the third and seventh periods P3 and P7, and have a turn-off voltage level in the first, second, fourth to sixth, eighth, and ninth periods P1, P2, P4 to P6, P8, and P9.

The scan signal SPWM[k] may have a turn-on voltage level in the second period P2, and have a turn-off voltage level in the first and third to ninth periods P1 and P3 to P9.

The emission control signal EM[k] may have a turn-on voltage level in the fourth and eighth periods P4 and P8, and have a turn-off voltage level in the first to third, fifth to seventh, and ninth periods P1 to P3, P5 to P7, and P9.

The sweep signal SWP[k] may have a relatively high voltage level in the first to third, fifth to seventh, and ninth periods P1 to P3, P5 to P7, and P9, and linearly decrease from the relatively high voltage level to a relatively low voltage level in the fourth and eighth periods P4 and P8.

The bypass gate signal BCB[k] may have a turn-on voltage level in the first to third, fifth to seventh, and ninth periods P1 to P3, P5 to P7, and P9, and have a turn-off voltage level in the fourth and eighth periods P4 and P8.

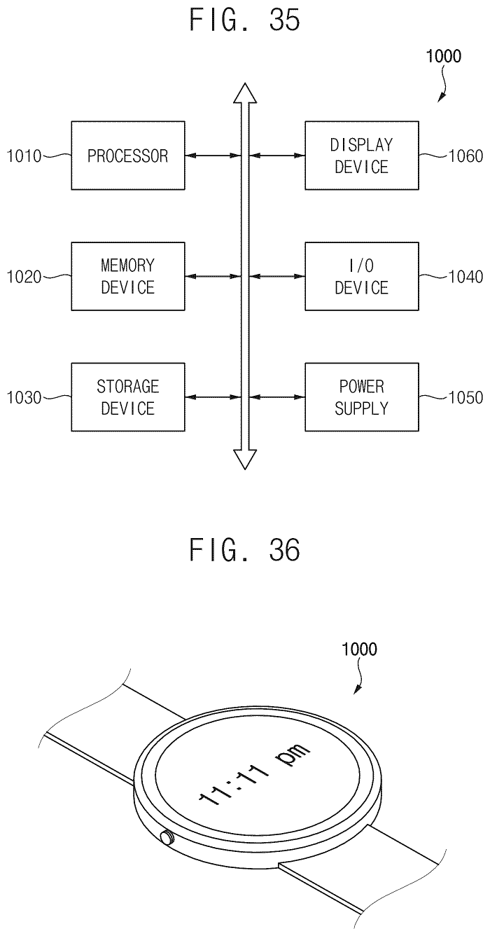

FIG. 35 is a block diagram showing an electronic device 1000. FIG. 36 is a view showing an embodiment in which the electronic device 1000 of FIG. 35 is implemented as a smart watch.

Referring to FIGS. 35 and 36, an electronic device 1000 may include a processor 1010, a memory device 1020, a storage device 1030, an input/output (“I/O”) device 1040, a power supply 1050, and a display device 1060. The electronic device 1000 may further include a plurality of ports capable of communicating with a video card, a sound card, a memory card, a universal serial bus (“USB”) device, or the like, or communicating with other systems.

In an embodiment, as shown in FIG. 36, the electronic device 1000 may be implemented as a smart watch. However, the disclosure is not limited thereto, and in another embodiment, the electronic device 1000 may be implemented as a television, a mobile phone, a video phone, a smart pad, a tablet personal computer (“PC”), a vehicle navigation, a laptop computer, a head-mounted display, or the like.

The processor 1010 may perform predetermined calculations or tasks. In an embodiment, the processor 1010 may be a microprocessor, a central processing unit (“CPU”), or the like. The processor 1010 may be connected to other components through an address bus, a control bus, a data bus, or the like. In an embodiment, the processor 1010 may also be connected to an expansion bus such as a peripheral component interconnect (“PCI”) bus. In an embodiment, the processor 1010 may provide first image data (IMD1 of FIGS. 1, 24, 27, and 31) and a control signal (CNT of FIGS. 1, 24, 27, and 31) to the display device 1060.

The memory device 1020 may store data desired for an operation of the electronic device 1000. In an embodiment, the memory device 1020 may include a nonvolatile memory device such as an erasable programmable read-only memory (“EPROM”), an electrically erasable programmable read-only memory (“EEPROM”), a flash memory, a phase change random access memory (“PRAM”), a resistance random access memory (“RRAM”), a nano floating gate memory (“NFGM”), a polymer random access memory (“PoRAM”), a magnetic random access memory (“MRAM”), or a ferroelectric random access memory (“FRAM”); and/or a volatile memory device such as a dynamic random access memory (“DRAM”), a static random access memory (“SRAM”), or a mobile DRAM, for example.

The storage device 1030 may include a solid state drive (“SSD”), a hard disk drive (“HDD”), a compact disc read-only memory (“CD-ROM”), or the like. The I/O device 1040 may include an input device such as a keyboard, a keypad, a touch pad, a touch screen, or a mouse; and an output device such as a speaker or a printer. The power supply 1050 may supply a power desired for the operation of the electronic device 1000. The display device 1060 may be connected to other components through the buses or other communication links. The display device 1060 may correspond to the display device 100 of FIG. 1, the display device 101 of FIG. 24, the display device 102 of FIG. 27, and the display device 103 of FIG. 31. Accordingly, the display device 1060 may include a pixel operated (or driven) by a pulse width modulation (“PWM”) scheme such as the pixel PX[k] shown in FIGS. 3, 17, 20, 23, 25, 28, and 32.

The display device in the embodiments may be applied to a display device included in a computer, a notebook, a mobile phone, a smart phone, a smart pad, a smart watch, a portable media player (“PMP”), a personal digital assistance (“PDA”), a motion pictures expert group audio layer III (“MP3”) player, or the like.

Although the pixels and the display devices in the embodiments have been described with reference to the drawings, the illustrated embodiments are examples, and may be modified and changed by a person having ordinary knowledge in the relevant technical field without departing from the technical spirit described in the following claims.

What is claimed is:

1. A pixel, comprising:
a light-emitting element including a first electrode, and a second electrode connected to a low power line which transmits a low power voltage;
a pulse width modulator which controls an emission time duration of the light-emitting element based on a data voltage, the pulse width modulator including:
a first driving transistor including:
a gate electrode connected to a first node;
a first electrode connected to a second node; and
a second electrode connected to a third node; and
an N-type transistor connected to the gate electrode, the first electrode and the second electrode of the first driving transistor; and
a constant current generator which provides a driving current having a constant level to the light-emitting element based on a constant current generation voltage, the constant current generator including:
a second driving transistor including:
a gate electrode connected to a fourth node;
a first electrode connected to a fifth node; and
a second electrode connected to a sixth node; and
an N-type transistor connected to the gate electrode, the first electrode and the second electrode of the second driving transistor.

2. The pixel of claim 1, wherein the pulse width modulator further includes:
a first write transistor including:
a gate electrode which receives a scan signal;
a first electrode connected to a data line which transmits the data voltage; and
a second electrode connected to the second node;
a first compensation transistor including:
a gate electrode which receives the scan signal;
a first electrode connected to the third node; and
a second electrode connected to the first node;
a first emission control transistor including:
a gate electrode which receives an emission control signal;
a first electrode which receives a first high power voltage; and
a second electrode connected to the second node;
a second emission control transistor including:
a gate electrode which receives the emission control signal;
a first electrode connected to the third node; and
a second electrode connected to the fourth node;
a first initialization transistor including:
a gate electrode which receives a first initialization gate signal;
a first electrode which receives a first initialization voltage; and
a second electrode connected to the first node; and
a first capacitor including:
a first electrode which receives a sweep signal; and
a second electrode connected to the first node.

3. The pixel of claim 2, wherein the first driving transistor is a P-type transistor, and
each of the first write transistor and the first compensation transistor is an N-type transistor.

4. The pixel of claim 3, wherein the first initialization transistor is an N-type transistor.

5. The pixel of claim 3, wherein each of the first emission control transistor and the second emission control transistor is an N-type transistor.

6. The pixel of claim 2, wherein the constant current generator further includes:
a second write transistor including:
a gate electrode which receives a constant current generation scan signal;
a first electrode connected to the data line which transmits the constant current generation voltage; and
a second electrode connected to the fifth node;
a second compensation transistor including:
a gate electrode which receives the constant current generation scan signal;
a first electrode connected to the sixth node; and
a second electrode connected to the fourth node;
a third emission control transistor including:
a gate electrode which receives the emission control signal;
a first electrode which receives a second high power voltage; and
a second electrode connected to the fifth node;
a fourth emission control transistor including:
a gate electrode which receives the emission control signal;
a first electrode connected to the sixth node; and
a second electrode connected to the first electrode of the light-emitting element;
a second initialization transistor including:
a gate electrode which receives a second initialization gate signal;
a first electrode which receives the first initialization voltage; and
a second electrode connected to the fourth node;
a bypass transistor including:
a gate electrode which receives a bypass gate signal;
a first electrode connected to a second initialization voltage line which transmits a second initialization voltage; and
a second electrode connected to the first electrode of the light-emitting element; and
a second capacitor including:
a first electrode which receives the second high power voltage; and a second electrode connected to the fourth node.

7. The pixel of claim 6, wherein the second driving transistor is a P-type transistor, and
each of the second write transistor and the second compensation transistor is an N-type transistor.

8. The pixel of claim 7, wherein the second initialization transistor is an N-type transistor.

9. The pixel of claim 7, wherein each of the third emission control transistor and the fourth emission control transistor is an N-type transistor.

10. The pixel of claim 7, wherein the bypass transistor is an N-type transistor.

11. The pixel of claim 6, wherein the second initialization voltage line is separated from the low power line.

12. The pixel of claim 11, wherein a voltage level of the second initialization voltage is higher than or equal to a voltage level of the low power voltage.

13. The pixel of claim 6, wherein a voltage level of the first high power voltage is higher than a voltage level of the second high power voltage.

14. The pixel of claim 6, wherein one frame includes a display scan period in which the data voltage is written and a self scan period in which the data voltage is not written, and
the second initialization gate signal has a turn-on voltage level in a first initialization period within the display scan period and a second initialization period within the self scan period.

15. The pixel of claim 14, wherein the first initialization gate signal has a turn-on voltage level in the first initialization period, and has a turn-off voltage level in the second initialization period.

16. A pixel, comprising:
a light-emitting element including a first electrode, and a second electrode connected to a low power line which transmits a low power voltage;
a pulse width modulator which controls an emission time duration of the light-emitting element based on a data voltage; and
a constant current generator which provides a driving current having a constant level to the light-emitting element based on a constant current generation voltage, the constant current generator including:
a bypass transistor including:
a gate electrode which receives a bypass gate signal;
a first electrode connected to a second initialization voltage line which transmits a second initialization voltage and separated from the low power line; and
a second electrode connected to the first electrode of the light-emitting element.

17. The pixel of claim 16, wherein a voltage level of the second initialization voltage is higher than or equal to a voltage level of the low power voltage.

18. The pixel of claim 16, wherein the pulse width modulator includes:
a first driving transistor including:
a gate electrode connected to a first node;
a first electrode connected to a second node; and
a second electrode connected to a third node;
a first write transistor including:
a gate electrode which receives a scan signal;
a first electrode connected to a data line which transmits the data voltage; and
a second electrode connected to the second node;
a first compensation transistor including:
a gate electrode which receives the scan signal;
a first electrode connected to the third node; and
a second electrode connected to the first node;
a first emission control transistor including:
a gate electrode which receives an emission control signal;
a first electrode which receives a first high power voltage; and
a second electrode connected to the second node;
a second emission control transistor including:
a gate electrode which receives the emission control signal;
a first electrode connected to the third node; and
a second electrode connected to a fourth node;
a first initialization transistor including:
a gate electrode which receives a first initialization gate signal;
a first electrode which receives a first initialization voltage; and
a second electrode connected to the first node; and
a first capacitor including:
a first electrode which receives a sweep signal; and
a second electrode connected to the first node.

19. The pixel of claim 18, wherein the first driving transistor is a P-type transistor, and
at least one of the first write transistor, the first compensation transistor, and the first initialization transistor is an N-type transistor.

20. The pixel of claim 18, wherein the constant current generator further includes:
a second driving transistor including:
a gate electrode connected to the fourth node;
a first electrode connected to a fifth node; and
a second electrode connected to a sixth node;
a second write transistor including:
a gate electrode which receives a constant current generation scan signal;
a first electrode connected to the data line which transmits the constant current generation voltage; and
a second electrode connected to the fifth node;
a second compensation transistor including:
a gate electrode which receives the constant current generation scan signal;
a first electrode connected to the sixth node; and
a second electrode connected to the fourth node;
a third emission control transistor including:
a gate electrode which receives the emission control signal;
a first electrode which receives a second high power voltage; and
a second electrode connected to the fifth node;
a fourth emission control transistor including:
a gate electrode which receives the emission control signal;
a first electrode connected to the sixth node; and
a second electrode connected to the first electrode of the light-emitting element;
a second initialization transistor including:
a gate electrode which receives a second initialization gate signal;
a first electrode which receives the first initialization voltage; and
a second electrode connected to the fourth node; and
a second capacitor including:
a first electrode which receives the second high power voltage; and
a second electrode connected to the fourth node.

21. The pixel of claim 20, wherein the second driving transistor is a P-type transistor, and
at least one of the second write transistor, the second compensation transistor, and the second initialization transistor is an N-type transistor.

22. The pixel of claim 20, wherein a voltage level of the first high power voltage is higher than a voltage level of the second high power voltage.

23. A display device, comprising:
a display panel including:
a plurality of pixels, each of the plurality of pixels including:
a light-emitting element including a first electrode, and a second electrode connected to a low power line which transmits a low power voltage;
a pulse width modulator which controls an emission time duration of the light-emitting element based on a data voltage, the pulse width modulator including:
a first driving transistor including:
a gate electrode connected to a first node;
a first electrode connected to a second node; and
a second electrode connected to a third node; and
an N-type transistor connected to the gate electrode, the first electrode and the second electrode of the first driving transistor; and
a constant current generator which provides a driving current having a constant level to the light-emitting element based on a constant current generation voltage, the constant current generator including:
a second driving transistor including:
a gate electrode connected to a fourth node;
a first electrode connected to a fifth node; and
a second electrode connected to a sixth node; and
an N-type transistor connected to the gate electrode, the first electrode and the second electrode of the second driving transistor;
a scan driver which sequentially provides scan signals to the plurality of pixels; and
a data driver which provides the data voltage and the constant current generation voltage to each of the plurality of pixels.

24. The display device of claim 23, wherein the pulse width modulator further includes:
a first write transistor including:
a gate electrode which receives a scan signal of the scan signals;
a first electrode connected to a data line which transmits the data voltage; and
a second electrode connected to the second node;
a first compensation transistor including:
a gate electrode which receives the scan signal;
a first electrode connected to the third node; and
a second electrode connected to the first node;
a first emission control transistor including:
a gate electrode which receives an emission control signal;
a first electrode which receives a first high power voltage; and
a second electrode connected to the second node;
a second emission control transistor including:
a gate electrode which receives the emission control signal;
a first electrode connected to the third node; and
a second electrode connected to the fourth node;
a first initialization transistor including:
a gate electrode which receives a first initialization gate signal;
a first electrode which receives a first initialization voltage; and
a second electrode connected to the first node; and
a first capacitor including:
a first electrode which receives a sweep signal; and
a second electrode connected to the first node.

25. The display device of claim 24, wherein the constant current generator further includes:
a second write transistor including:
a gate electrode which receives a constant current generation scan signal;
a first electrode connected to the data line which transmits the constant current generation voltage; and
a second electrode connected to the fifth node;
a second compensation transistor including:
a gate electrode which receives the constant current generation scan signal;
a first electrode connected to the sixth node; and
a second electrode connected to the fourth node;
a third emission control transistor including:
a gate electrode which receives the emission control signal;
a first electrode which receives a second high power voltage; and
a second electrode connected to the fifth node;
a fourth emission control transistor including:
a gate electrode which receives the emission control signal;
a first electrode connected to the sixth node; and
a second electrode connected to the first electrode of the light-emitting element;
a second initialization transistor including:
a gate electrode which receives a second initialization gate signal;
a first electrode which receives the first initialization voltage; and
a second electrode connected to the fourth node;
a bypass transistor including:
a gate electrode which receives a bypass gate signal;
a first electrode connected to a second initialization voltage line which transmits a second initialization voltage; and
a second electrode connected to the first electrode of the light-emitting element; and
a second capacitor including:
a first electrode which receives the second high power voltage; and
a second electrode connected to the fourth node.

26. The display device of claim 25, wherein the second initialization voltage line is separated from the low power line.
